(19) United States
(12) Patent Application Publication
(10) Pub. No.: US 2021/0260418 A1
(43) Pub. Date: Aug. 26, 2021

(54) DROP-IN ANCHOR FOR BEAM CATENARY LINES

(71) Applicant: Alexander Andrew, Inc. DBA Falltech, Compton, CA (US)

(72) Inventors: Zachary Winters, Los Angeles, CA (US); Rafael Ramirez, Whittier, CA (US)

(21) Appl. No.: 17/180,736

(22) Filed: Feb. 20, 2021

Related U.S. Application Data
(60) Provisional application No. 62/979,926, filed on Feb. 21, 2020.

(51) Int. Cl. A62B 35/00

(52) U.S. Cl. CPC A62B 35/0068

(57) ABSTRACT

One embodiment includes a drop-in anchor for construction beam catenary lines that includes a top portion having a first diameter. An elongated body portion has a second diameter and is connected to the top portion. The elongated body portion including a through-hole of a third diameter. The elongated body portion is configured to fit within a construction beam through-hole having a fourth diameter. The through-hole of the elongated body portion is configured for connecting with a catenary line connector. The first diameter is larger than the fourth diameter.

### CROSS REFERENCE TO RELATED APPLICATIONS

This application claims priority from U.S. Provisional Patent Application Ser. No. 62/979,926, filed on Feb. 21, 2020, which is incorporated herein by reference in its entirety.

### COPYRIGHT DISCLAIMER

A portion of the disclosure of this patent document may contain material that is subject to copyright protection. The copyright owner has no objection to the facsimile reproduction by anyone of the patent document or the patent disclosure as it appears in the patent and trademark office patent file or records, but otherwise reserves all copyright rights whatsoever.

### BACKGROUND

To avoid bodily injury from an accidental fall, workmen, while working on beams (e.g., steel beams, I-beams, etc.), commonly wear a safety harness that is attached to a fall protection line and a connector (e.g., a snap hook, shackle, etc.) attached to a catenary or traveling restraint line extending between two secure points directly on a beam. One problem with catenary lines connected to a beam is that a shackles or loop connectors fitted through connecting through-holes of the beam become obstacles to workers working on top of the beam, which can cause a worker to trip and fall as they traverse the top of the beam.

### SUMMARY

The embodiments relate to beam drop-in anchors for beam catenary lines. Some embodiments include a drop-in anchor that has a shape for fitment within a through-hole in a beam (e.g., steel beams, I-beams, etc.) with a top portion having a size and shape larger than the through-hole, and an elongated body portion that is configured to fit within the through-hole of the beam, and having its own connecting through-hole that is configured for connecting with a shackle or loop of a catenary fall protection line underneath the beam. The through-hole of the body portion being configured to be disposed below a bottom portion of the beam through-hole. In some embodiments, the top portion has a thickness and shape with a dimension height above a top of the through-hole of the beam. The anchor body portion is elongated below a bottom of the beam through-hole. One embodiment includes a domed shaped top portion. Other embodiments have shapes such as square, round, oval, multi-faceted, polygonal, etc. The shape of the top portion and height of the top portion over the top of the beam provides for a much reduced hazard for workers traversing the top of the beam. The height of the top portion of the drop-in anchor is reduced from the conventional shackle or loop anchoring for catenary beam lines that are directly connected through the beam.

One embodiment includes a drop-in anchor for construction beam catenary lines that includes a top portion having a first diameter. An elongated body portion has a second diameter and is connected to the top portion. The elongated body portion including a through-hole of a third diameter. The elongated body portion is configured to fit within a construction beam through-hole having a fourth diameter. The through-hole of the elongated body portion is configured for connecting with a catenary line connector. The first diameter is larger than the fourth diameter.

### BRIEF DESCRIPTION OF THE DRAWINGS

FIGS. 1A-D show a conventional shackle and loop anchors for a construction beam catenary fall protection line.

FIG. 2 shows an original design concept, according to an embodiment.

FIGS. 3A-63C show multiple different designs for drop-in anchors for construction beam catenary fall protection lines, according to some embodiments.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

One embodiment includes a drop-in anchor for a beam catenary fall protection cable or line. The body portion of the drop-in anchor has a shape for fitment within a through-hole in the beam. A top portion of the drop-in anchor has a size and shape larger than a beam through-hole. The body portion that fits within the through-hole of the beam includes a connecting through-hole that is configured for connecting with a shackle or loop of the catenary fall protection cable or line. The through-hole of the body portion has a length configured to be disposed below a bottom portion of the beam through-hole. The shape of the top portion and height of the top portion reduces a hazard for workers traversing the top of the beam.

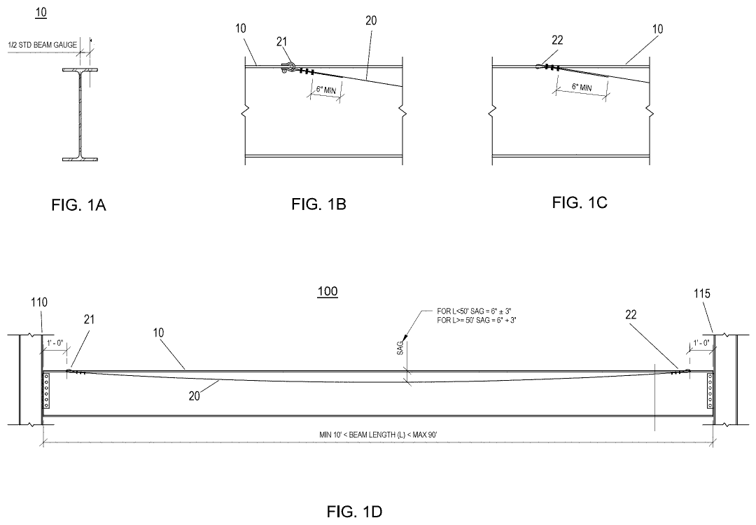

FIGS. 1A-D shows a conventional catenary (construction) beam line 100 system for a steel beam 10 (I-beam, etc.) where a through-hole in the steel beam 10 provides for connecting a ½ inch diameter shackle 21 (or loop 22) for an anchor. In FIG. 1D, between the shackles 21 and loop anchor 22 is the fall protection line 20 or cable (e.g., steel cable, etc.). Outside the two shackle 21 and loop 22 are stanchions 110 and 115, which may be optional depending on the set up. Typically, a worker that is working above the steel beam 10 attaches a lifeline or fall protection line 20 via a snap hook or similar connector to a fall protection harness. The shackles 21/22 or loop connectors are placed through the through-holes as shown, and protrude out above and below the through-hole. This protrusion poses a hazard as a worker traversing the steel beam 10 can trip or lose balance due to the exposed shackle 21/22 (or loop portion) above the steel beam 10, which can cause the worker to fall off the steel beam 10 and rely on the fall protection harness and lifeline to prevent the worker falling. When a worker falls off the steel beam 10 and the fall protection harness and other fall protection equipment (e.g., energy absorbers, self-retracting lifelines (SRLs), etc.) is employed, the fall protection equipment that serves its purpose may be compromised from being able to be used again (i.e., once a worker falls using the protection, the safety standard may be compromised, and the fall protection equipment needs to be replaced).

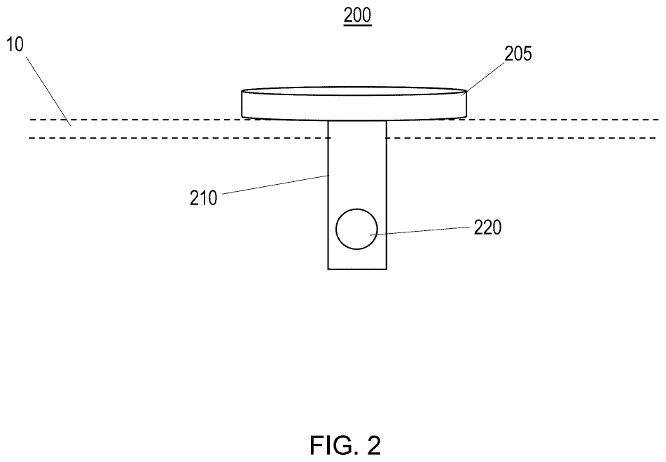

FIG. 2 shows an original design for a drop-in anchor 200, according to an embodiment. In this initial embodiment, the anchor 200 has a circular top portion 205 and a cylindrical body portion 210 including a through-hole 220 of, for example, ½ inch, for connecting to a shackle or loop. In one embodiment, the body portion 210 has a length between 2-3 inches, and the body portion through-hole 220 has a diameter of ½ inch. The diameter of the body portion 210 is 1 inch, which is designed to fit within a through-hole of a beam 10 (e.g., steel beam, I-beam, etc.), where the top portion 205 holds the anchor 200 to the beam 10. The top portion 205 diameter is larger than the beam 10 through-hole. The thickness of the top portion 205 is the maximum height above (e.g., ½ inch) the beam 10 for the anchor 200.

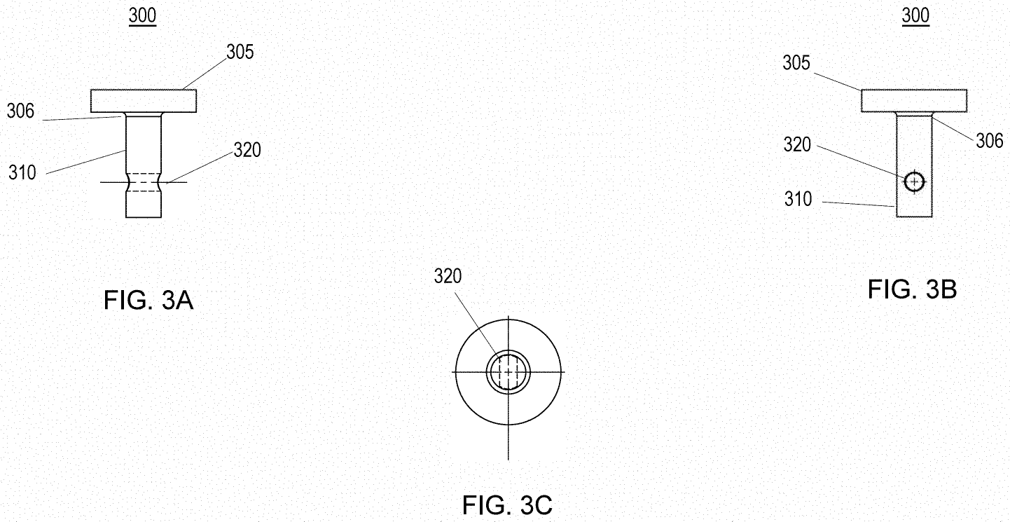

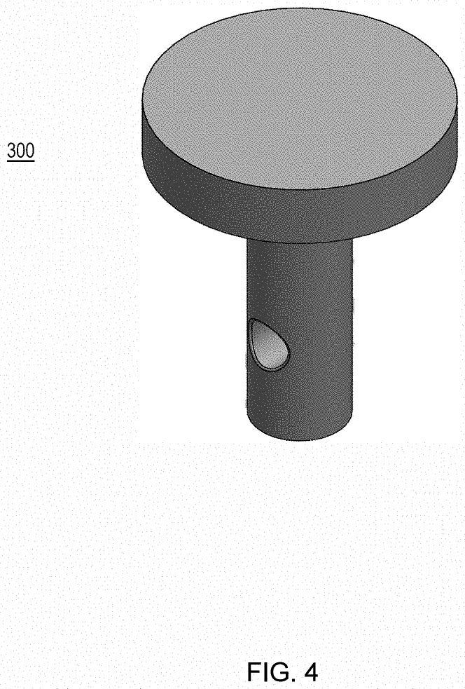

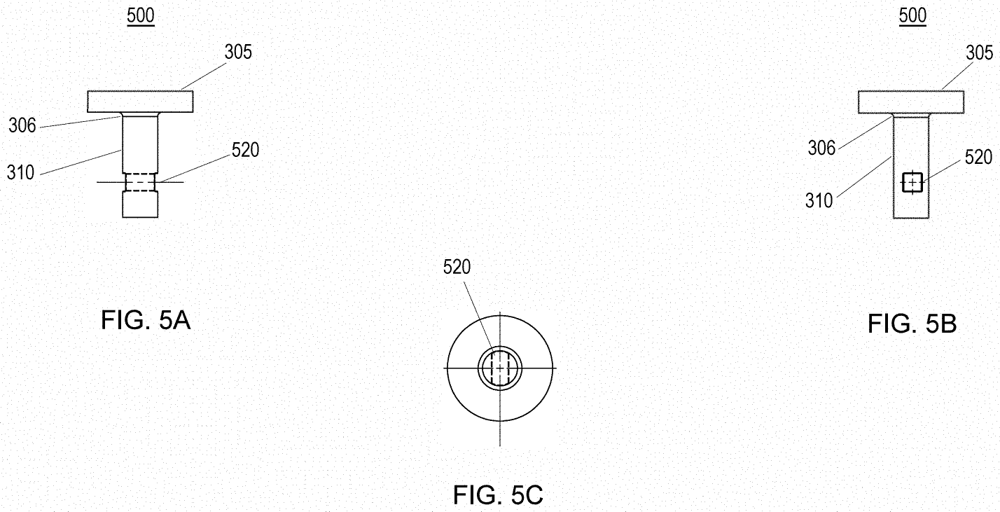

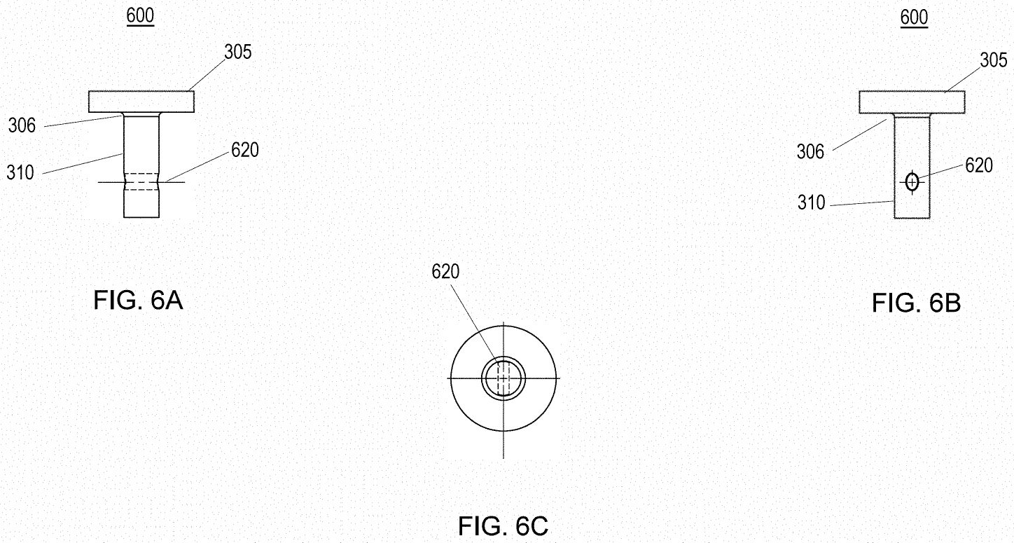

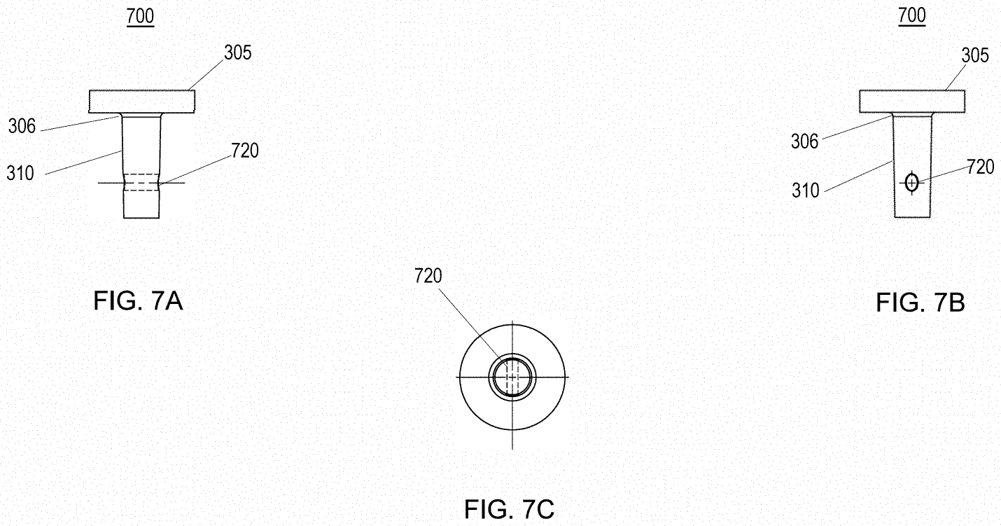

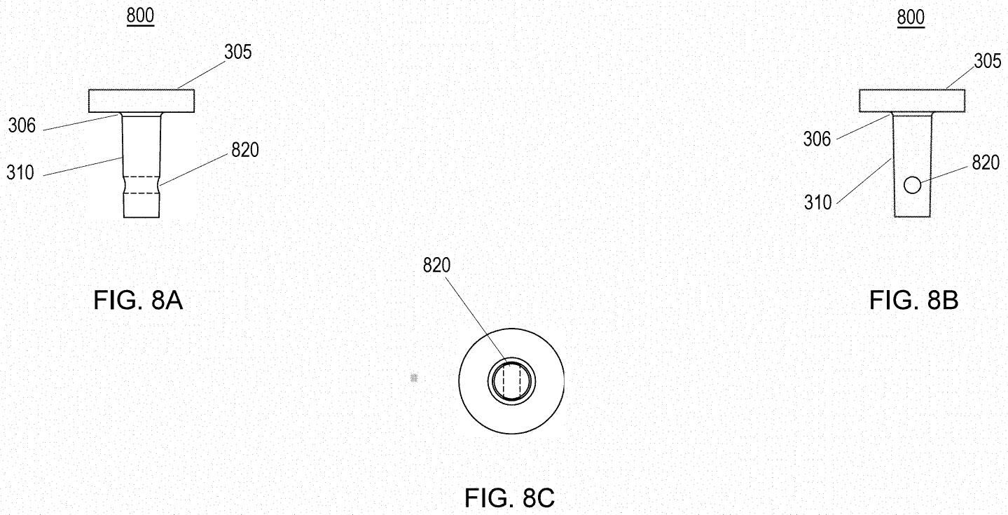

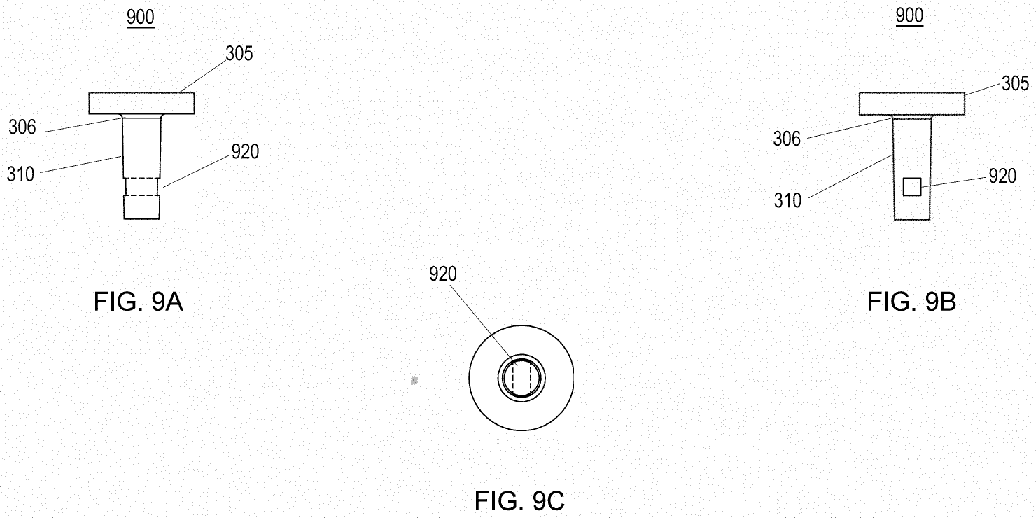

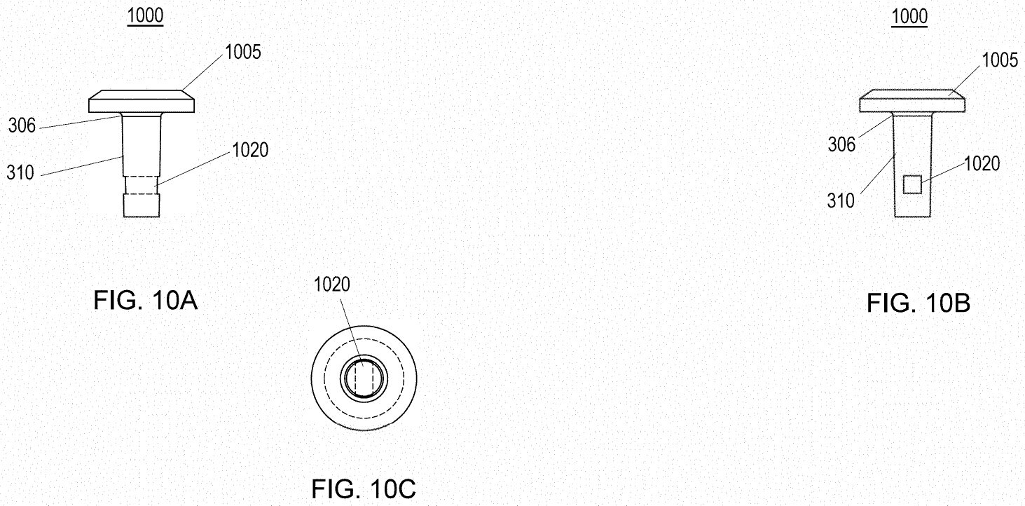

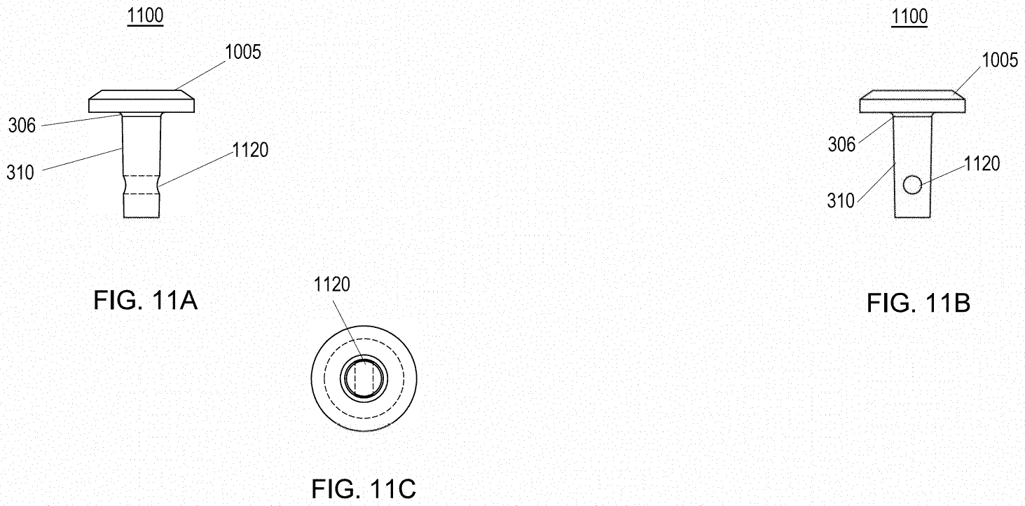

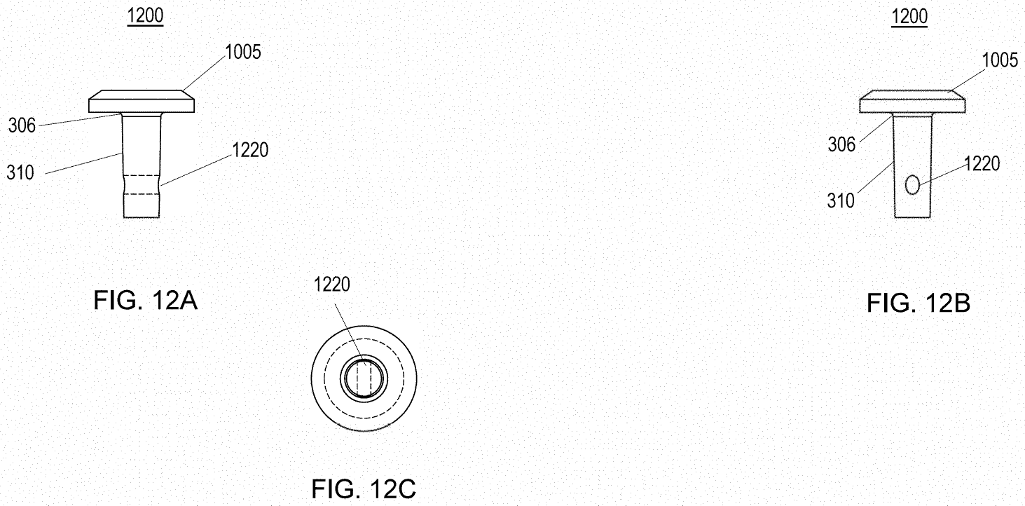

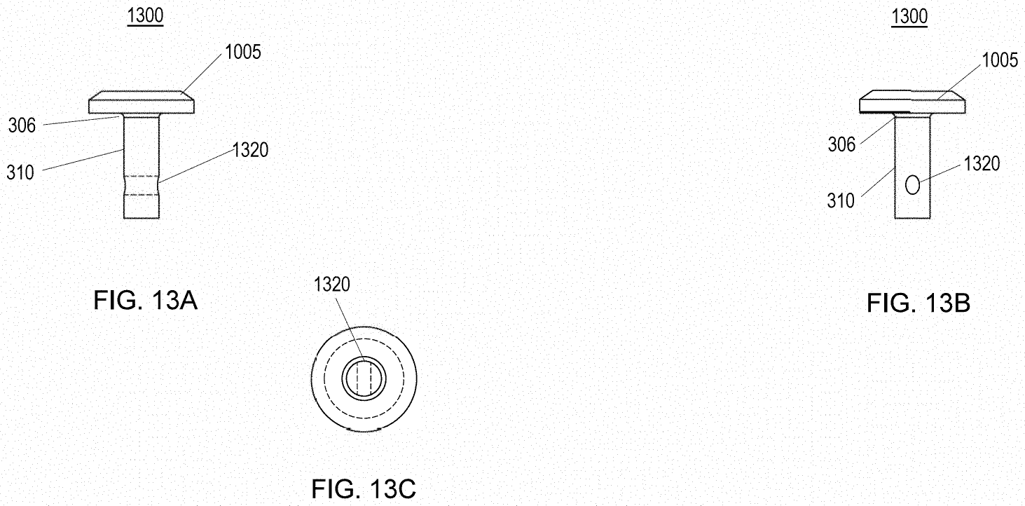

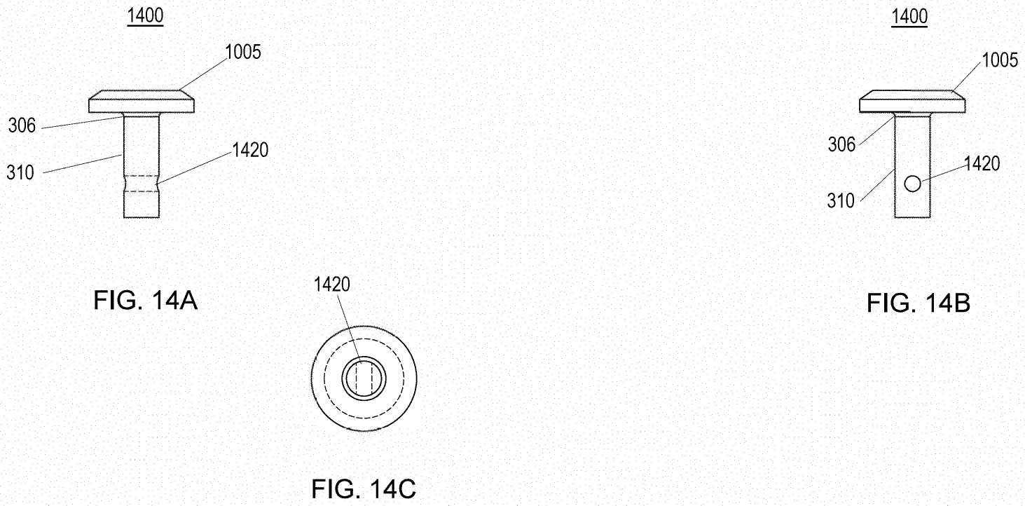

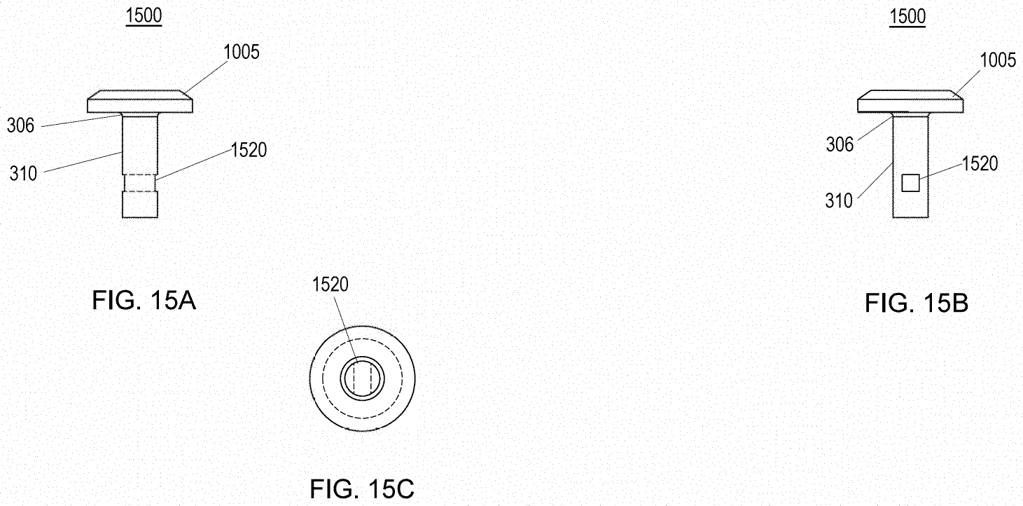

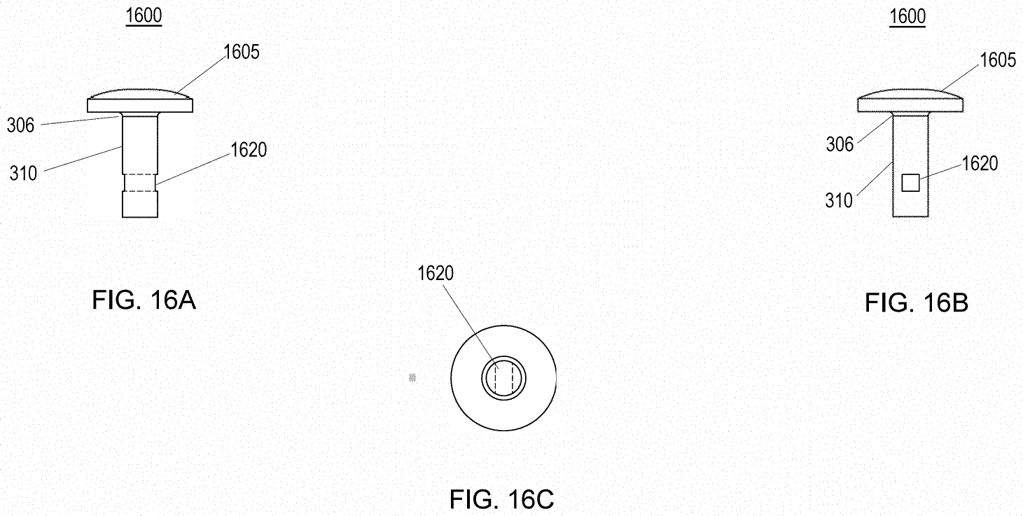

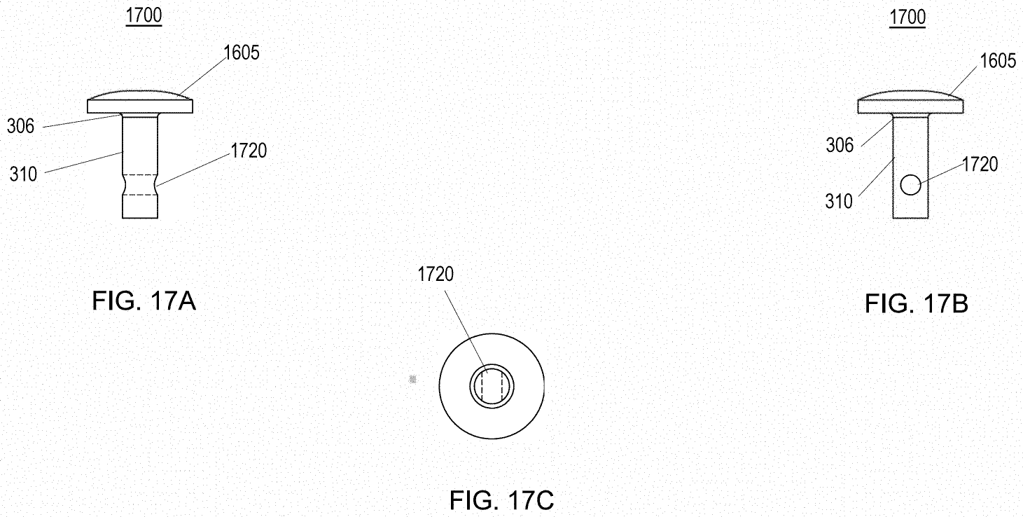

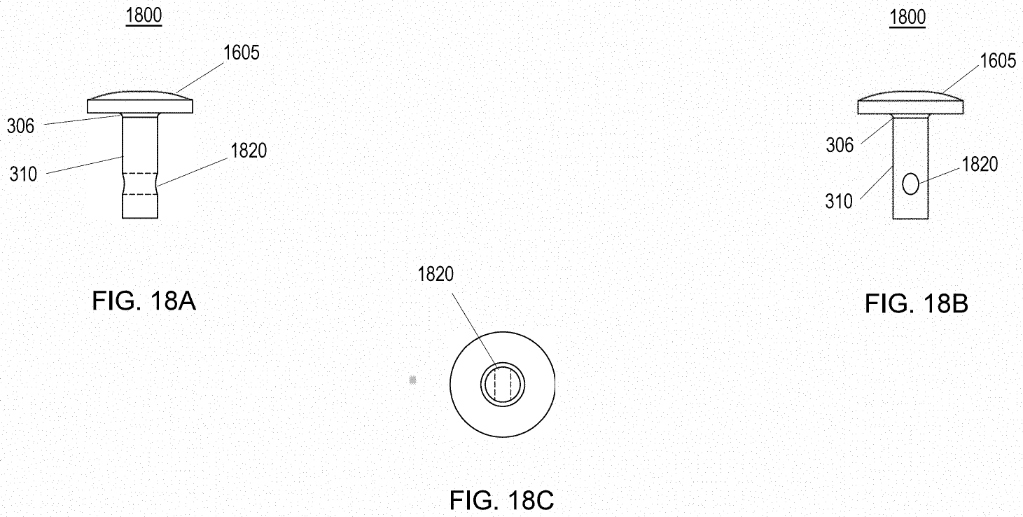

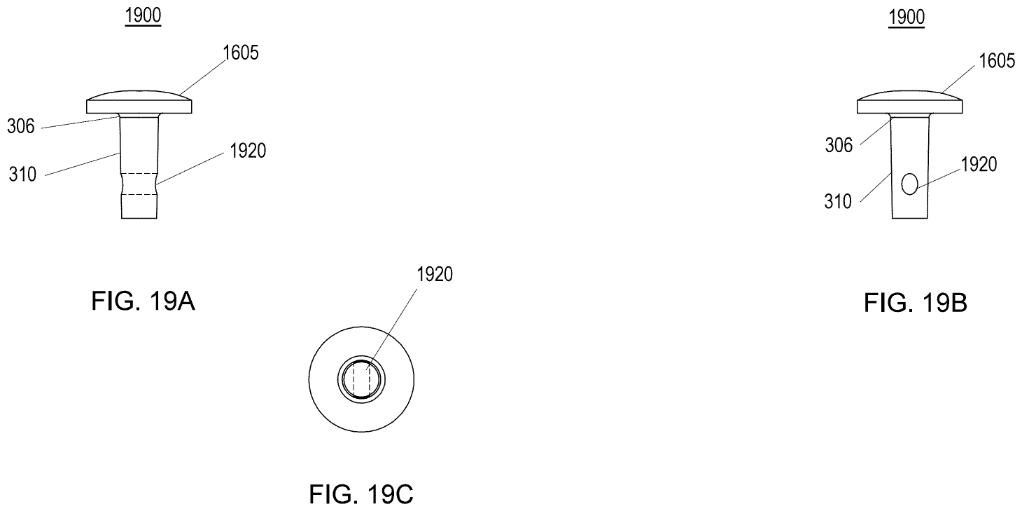

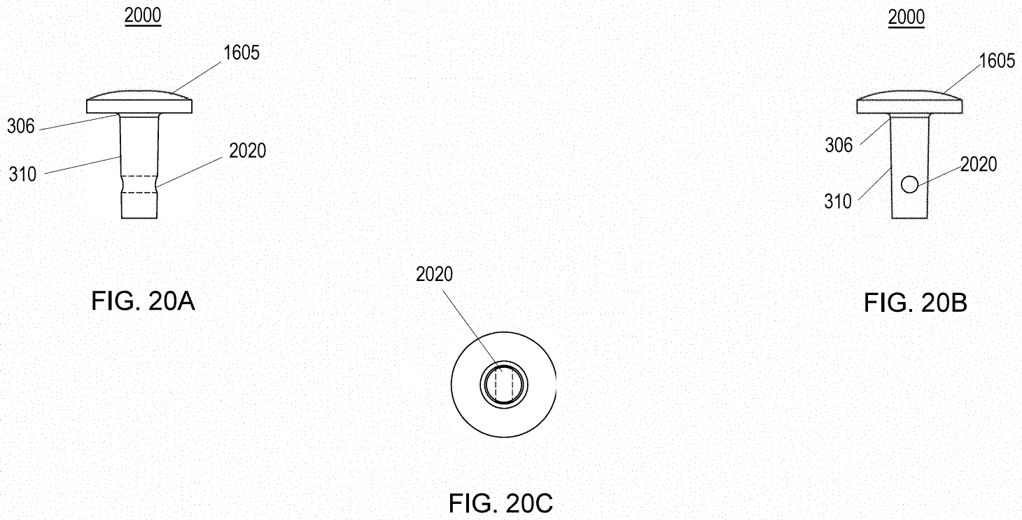

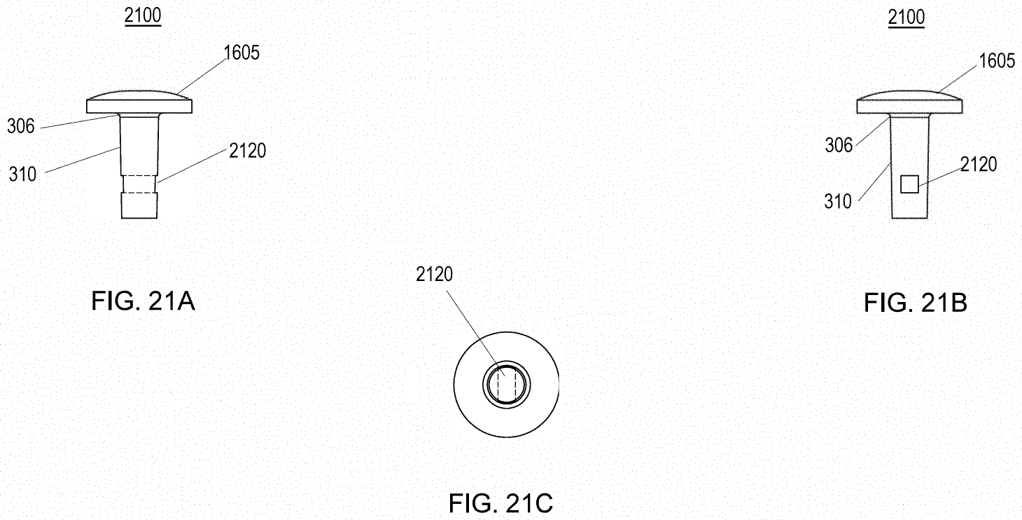

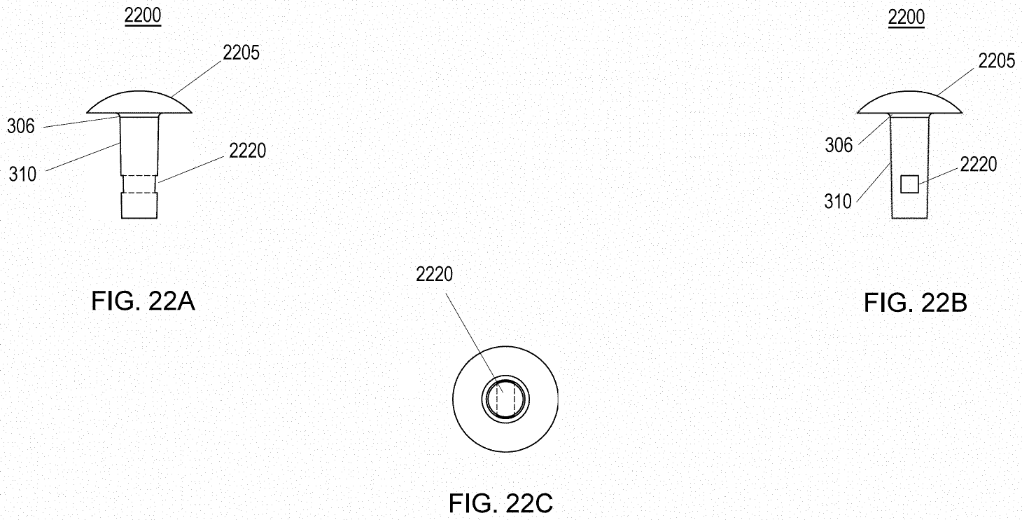

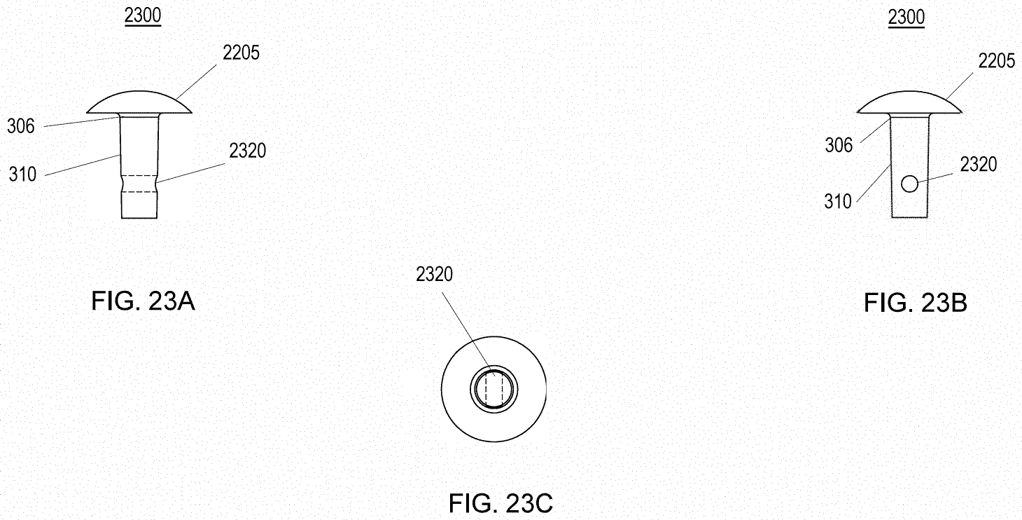

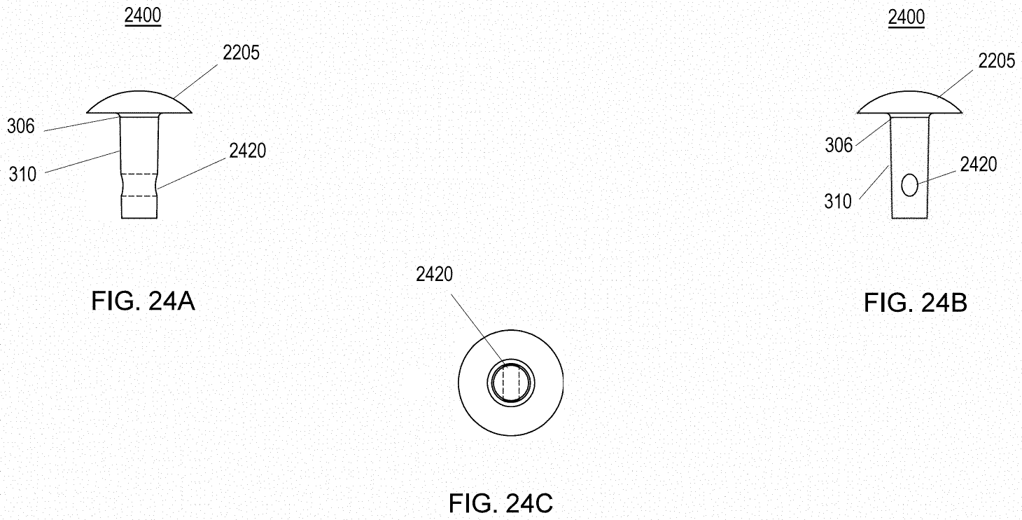

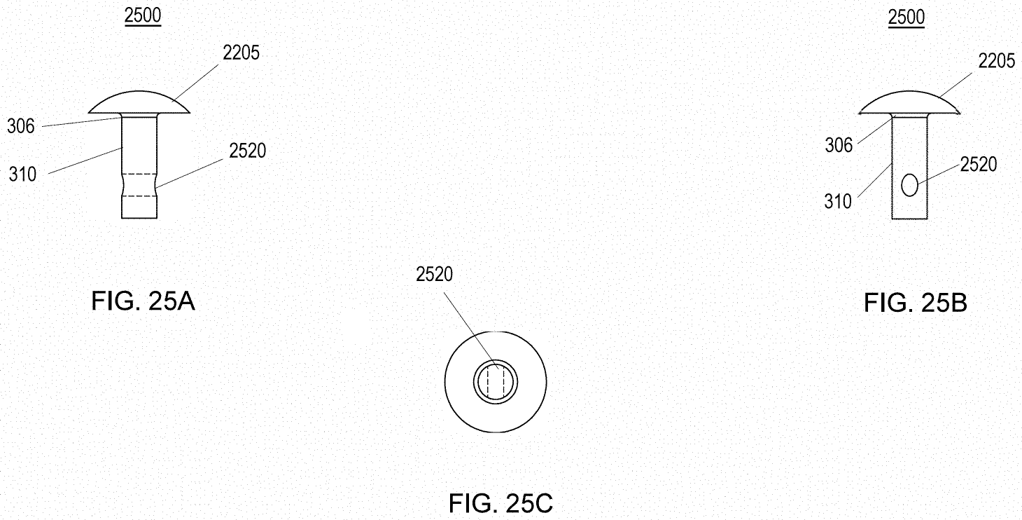

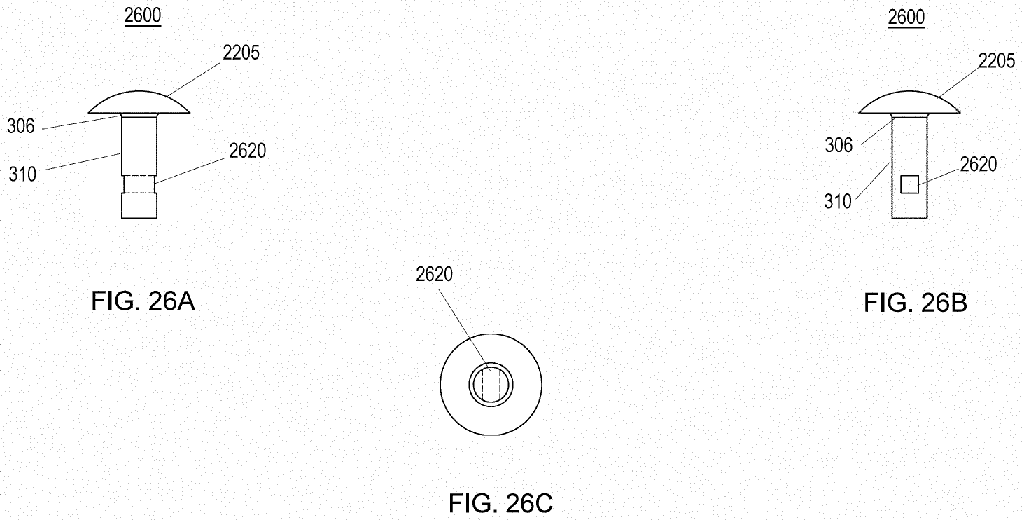

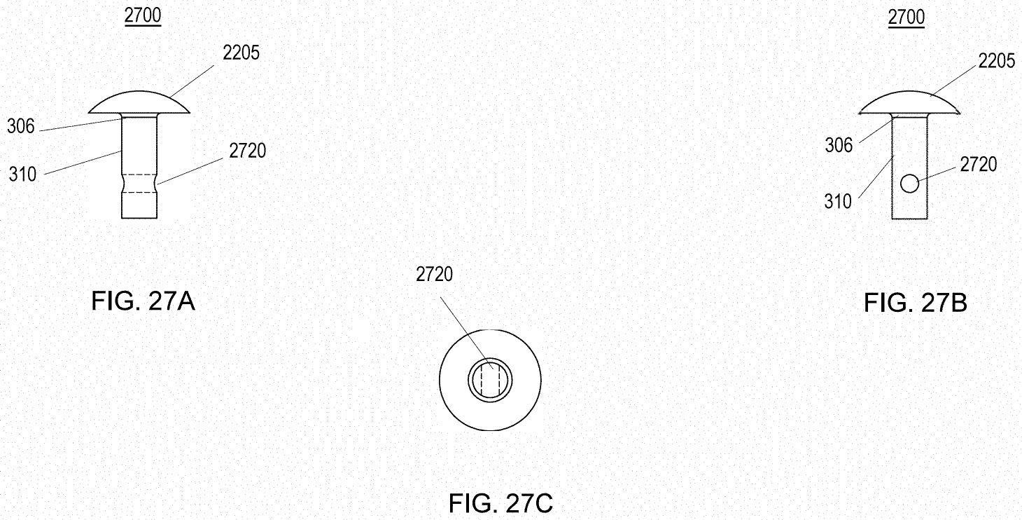

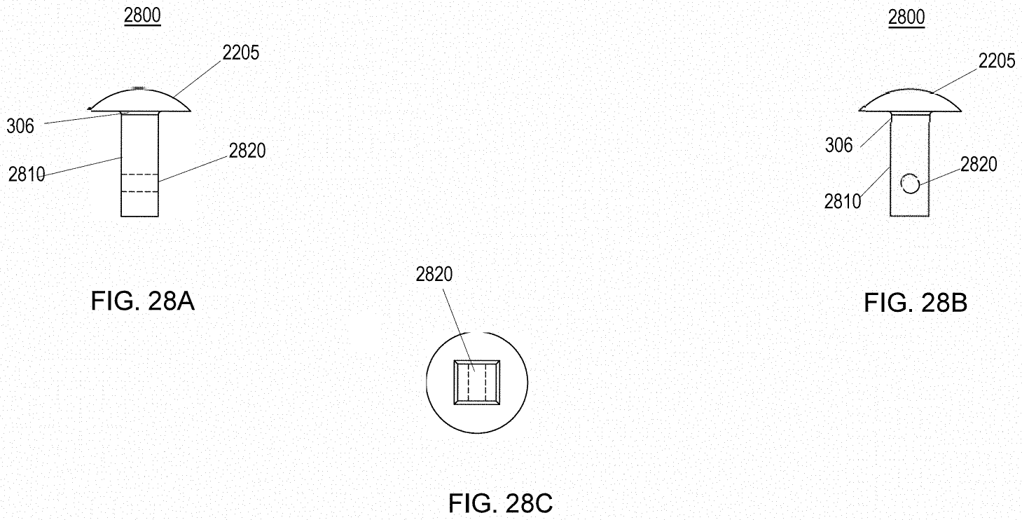

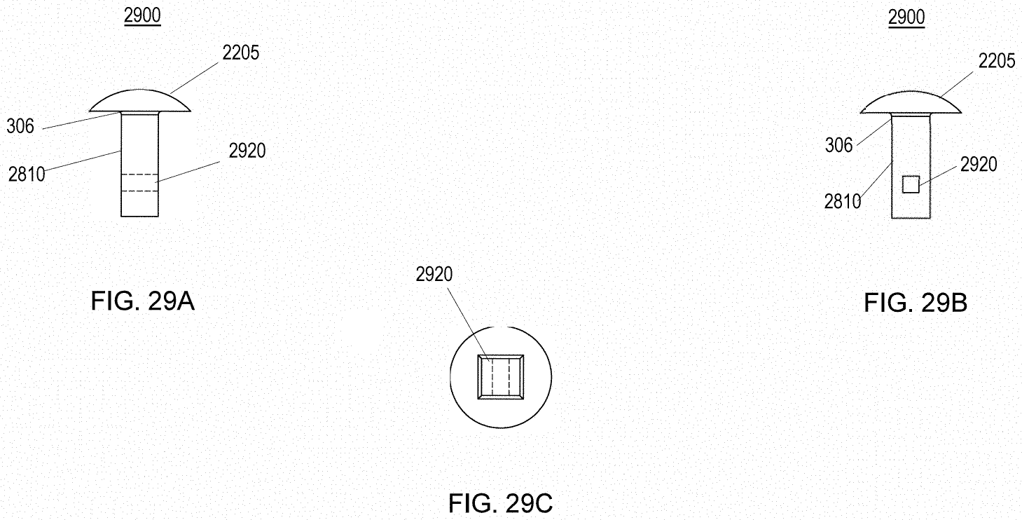

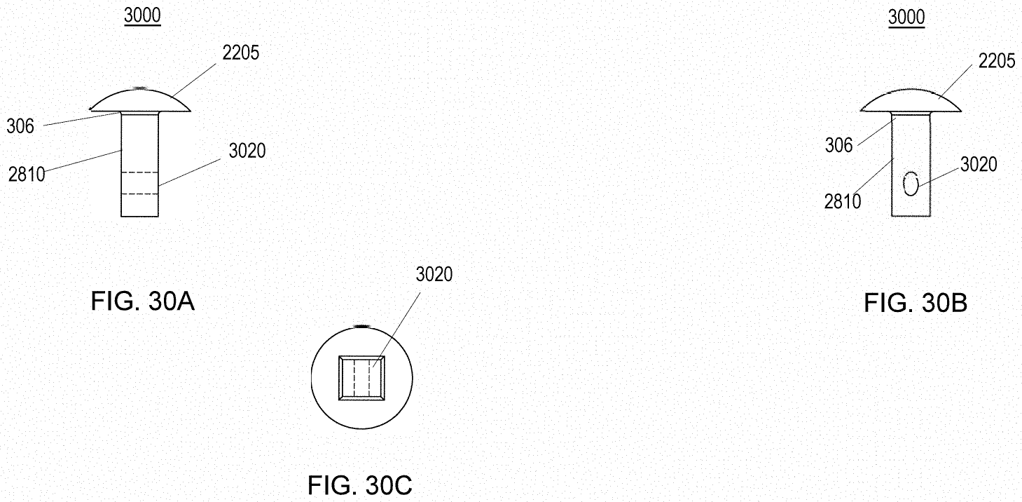

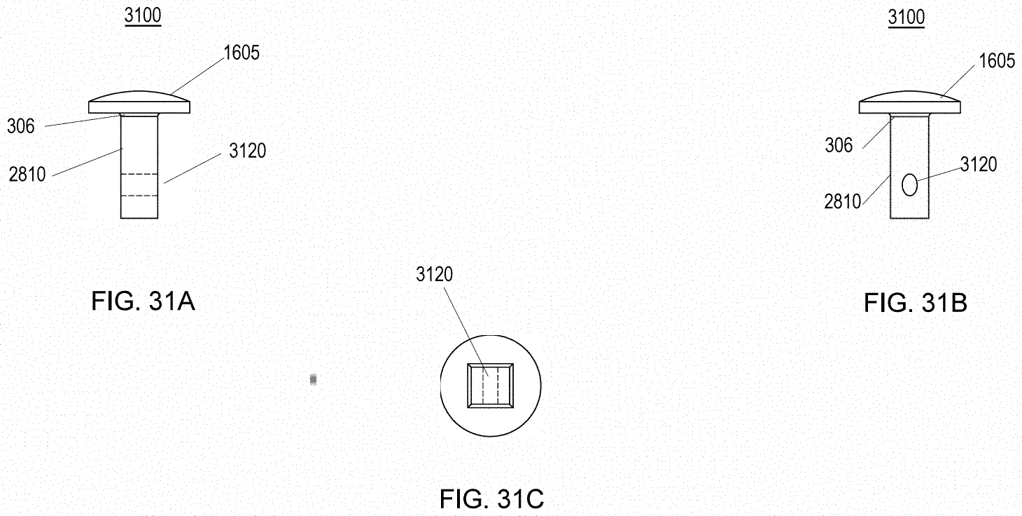

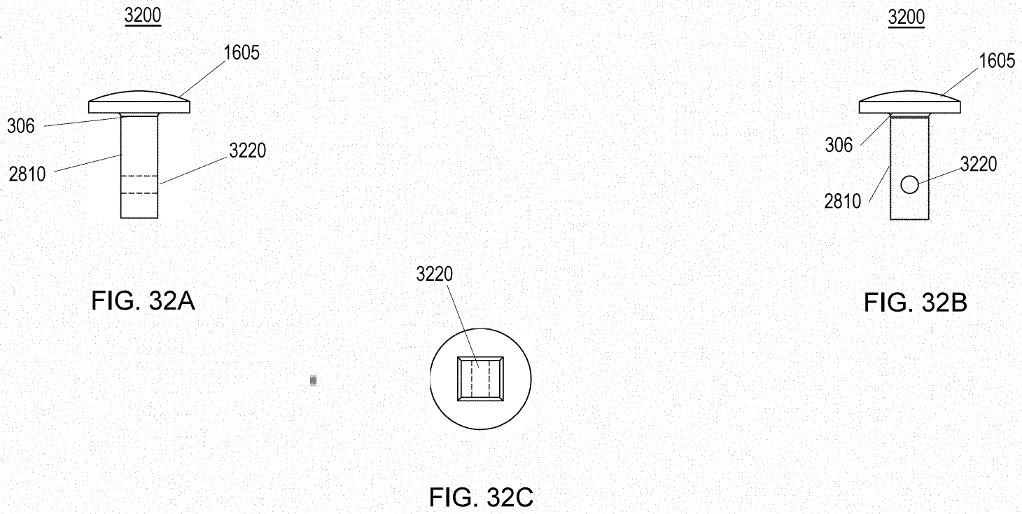

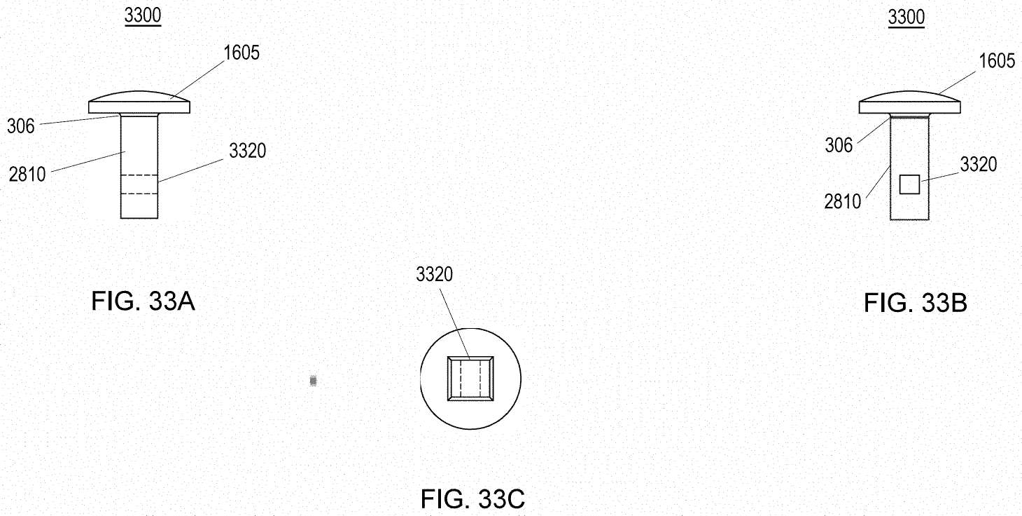

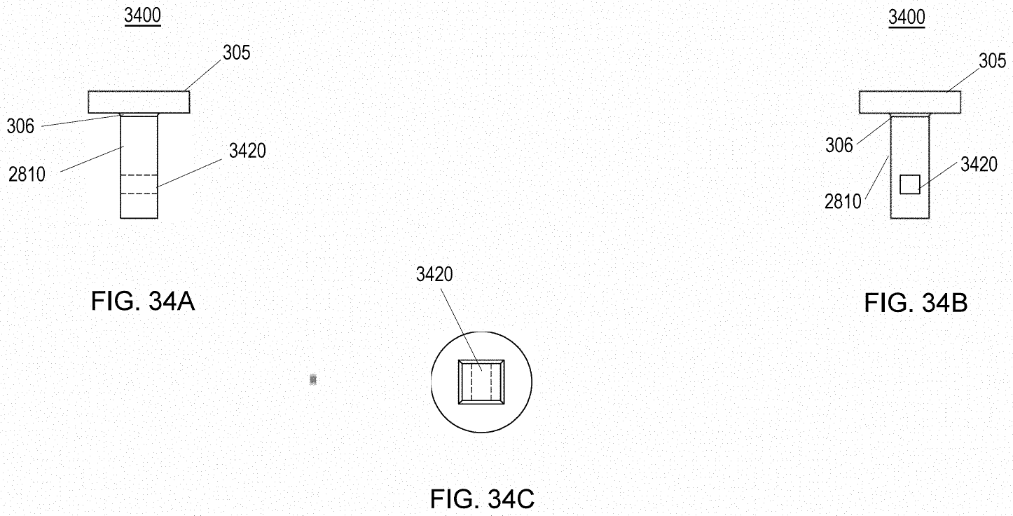

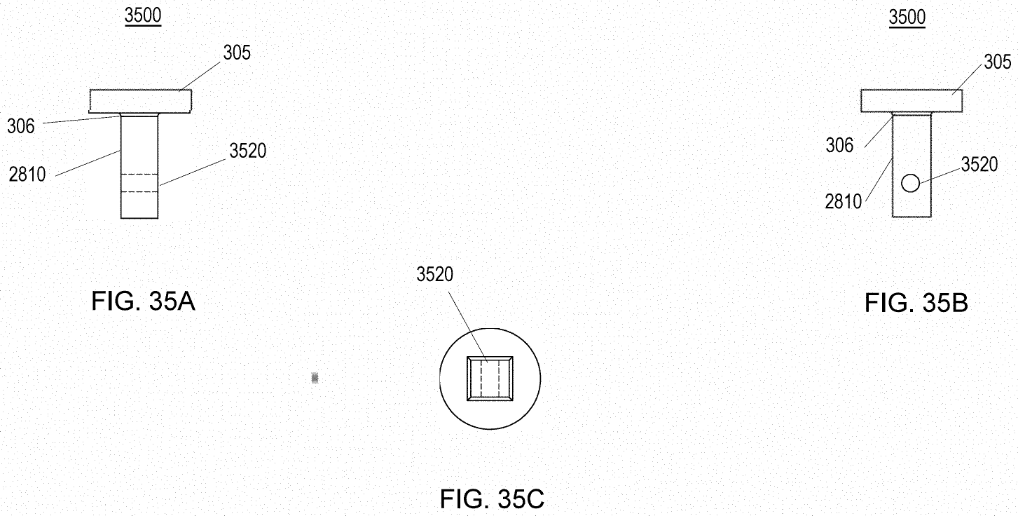

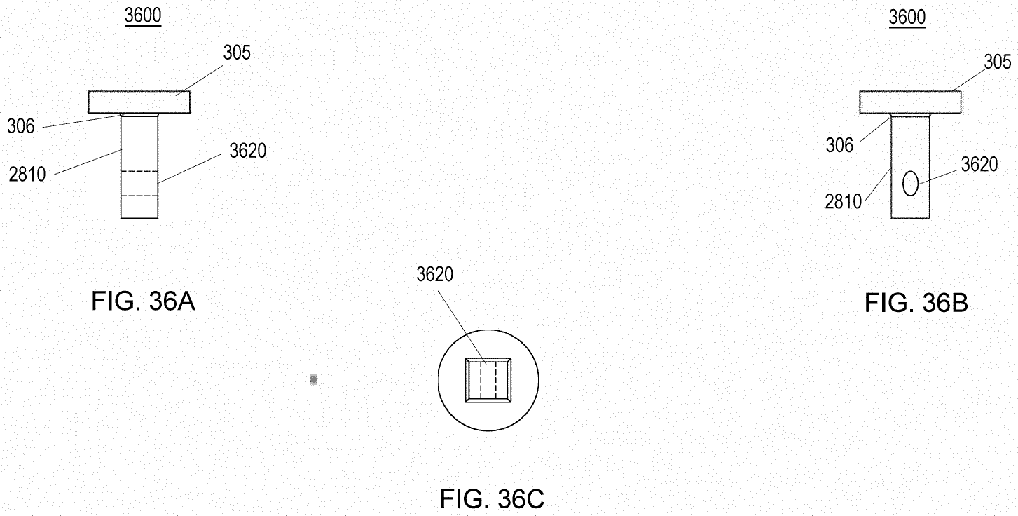

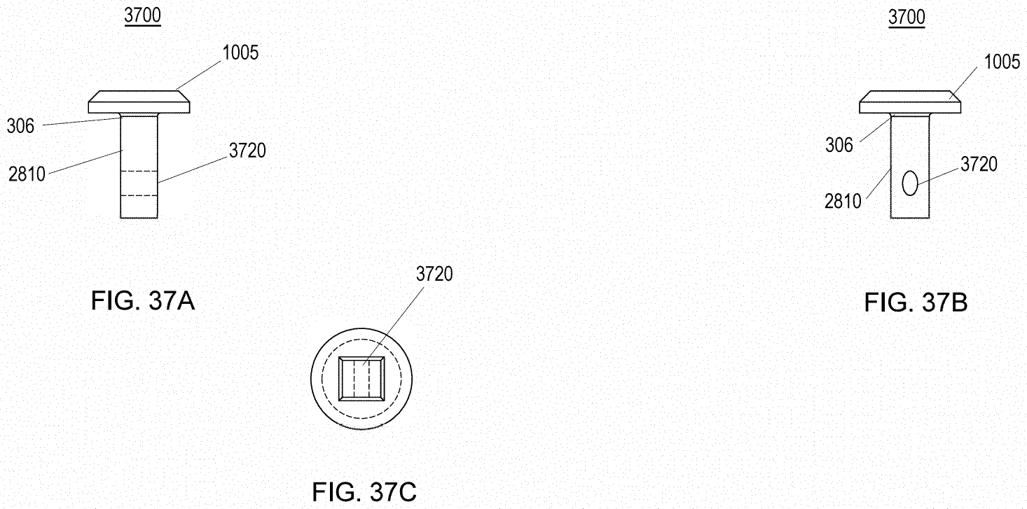

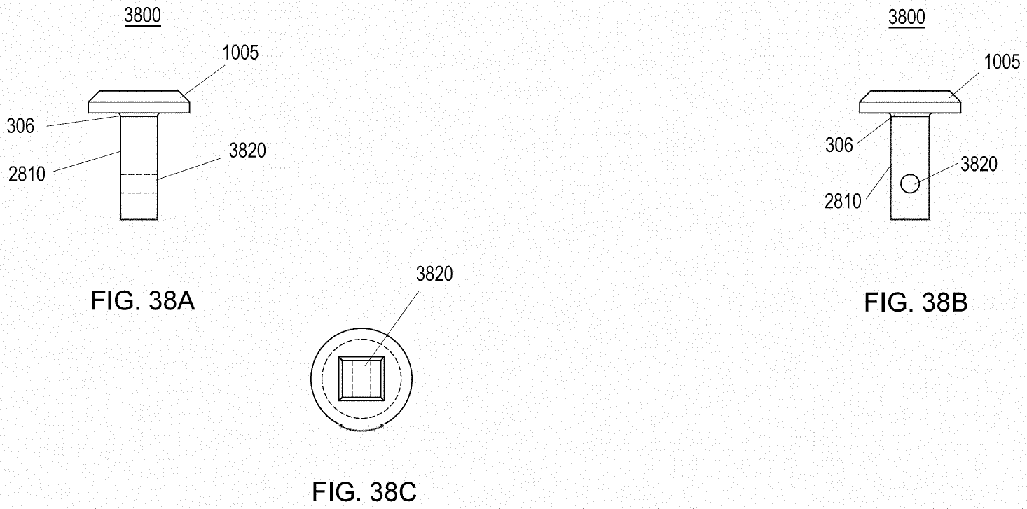

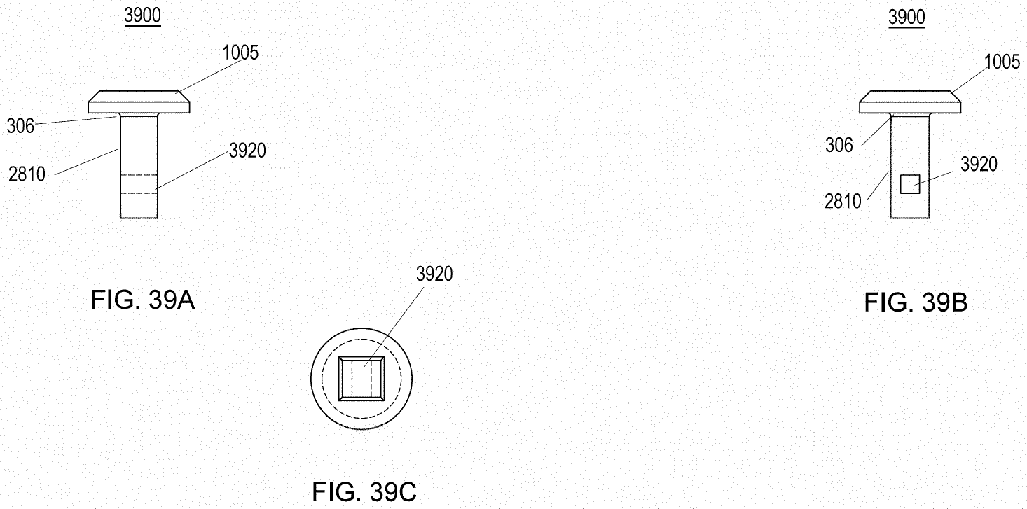

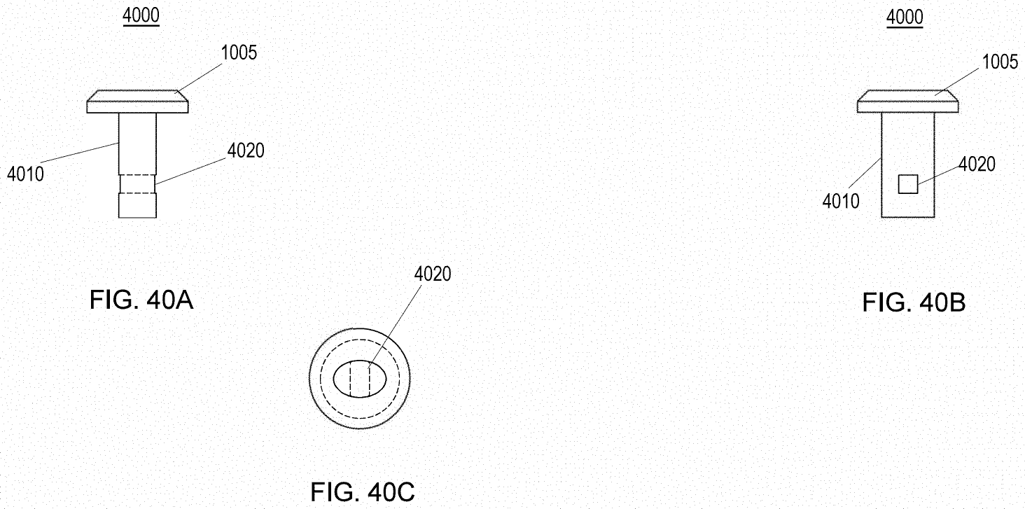

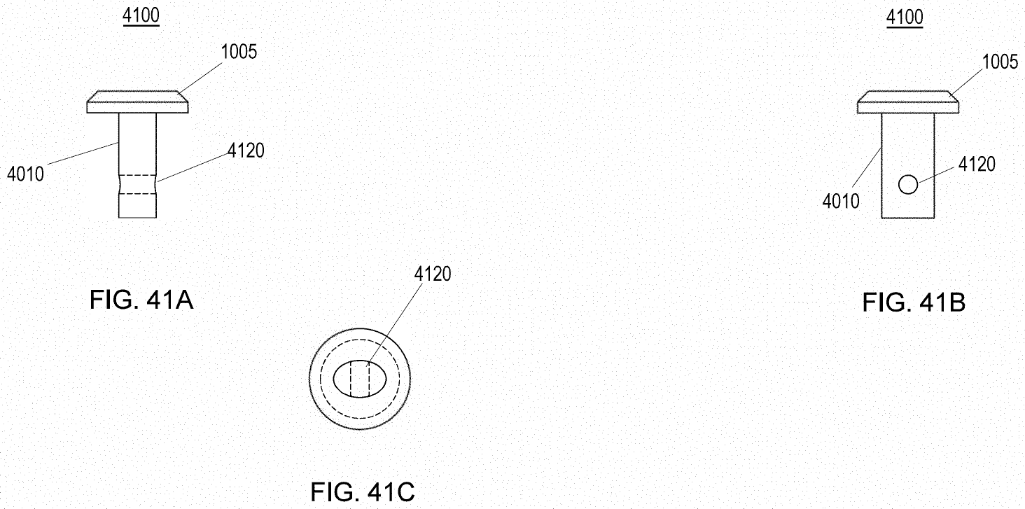

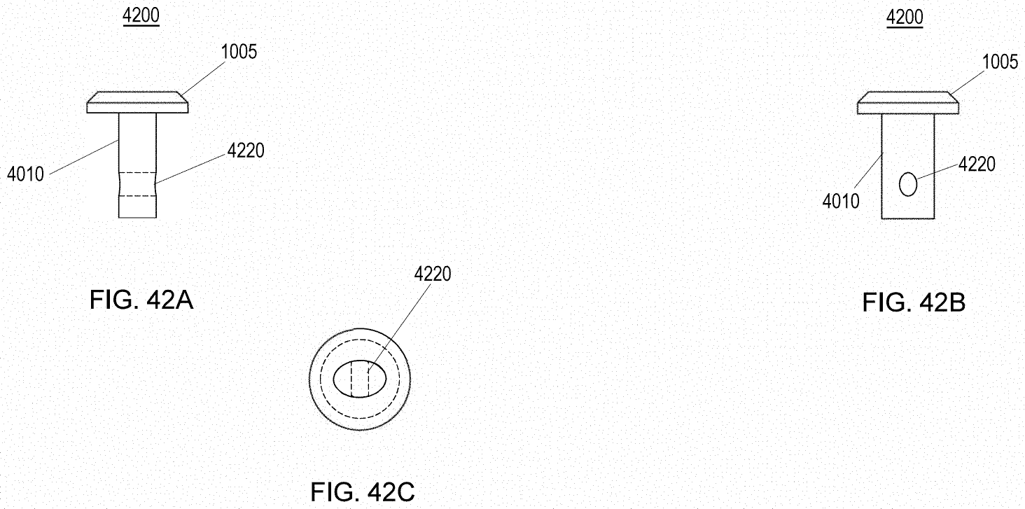

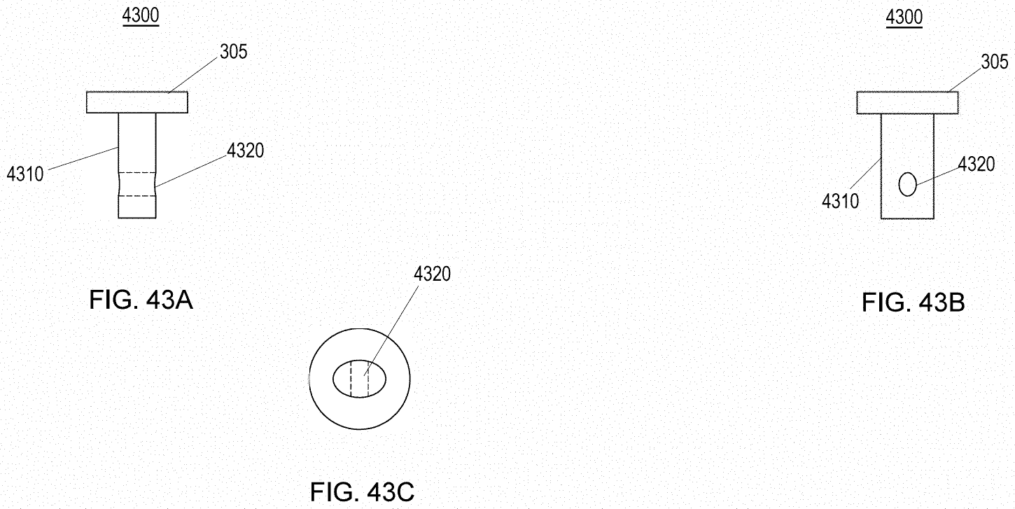

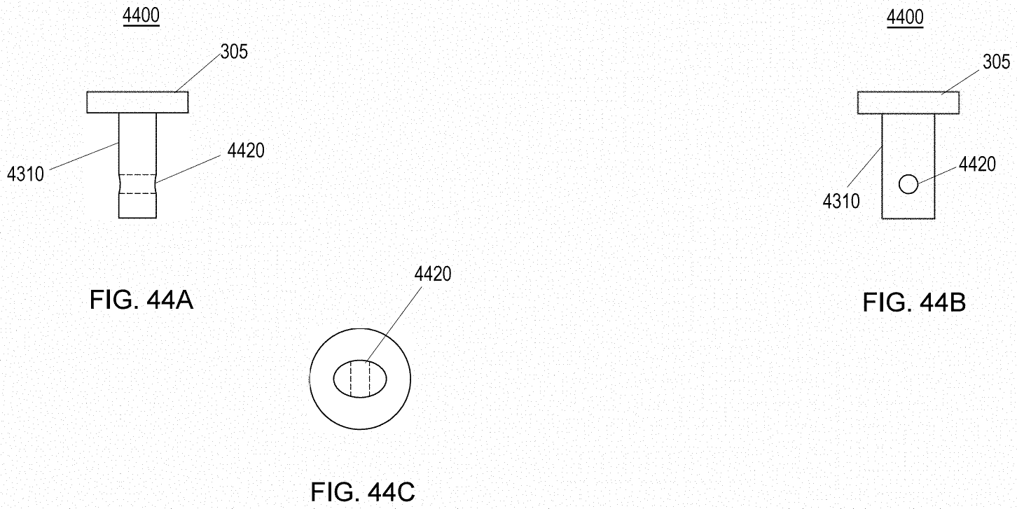

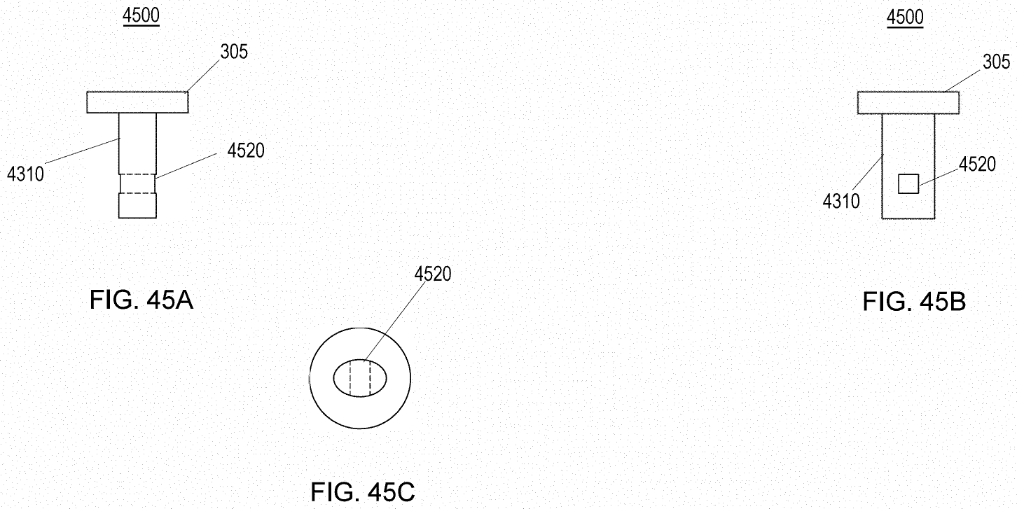

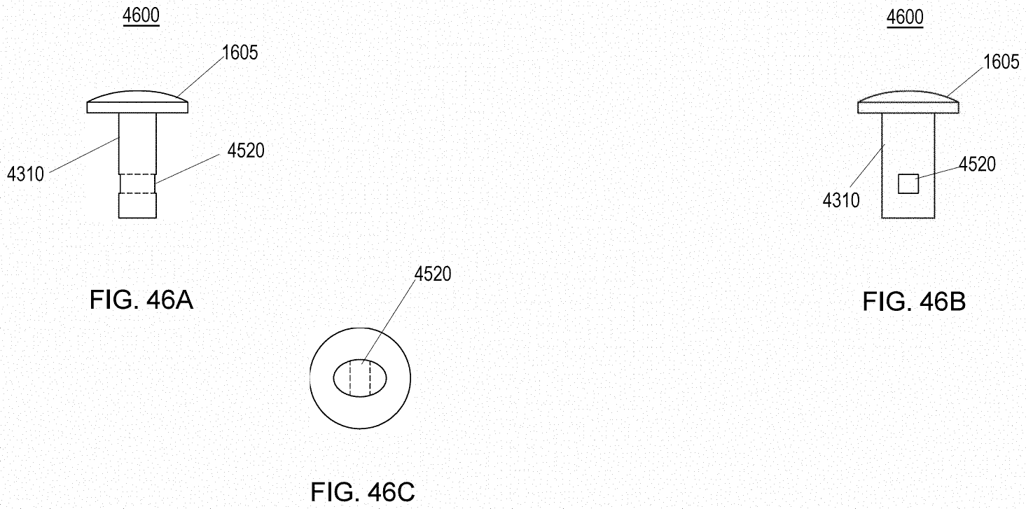

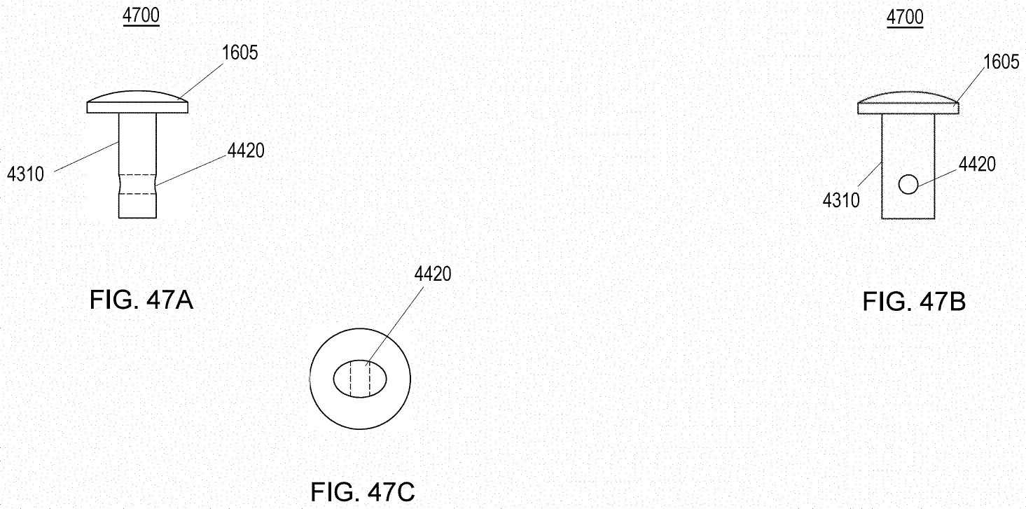

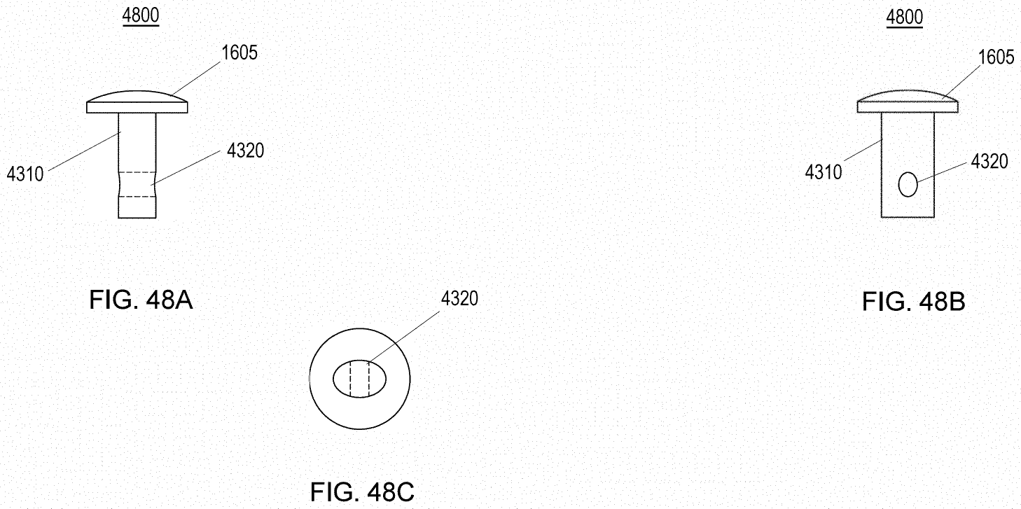

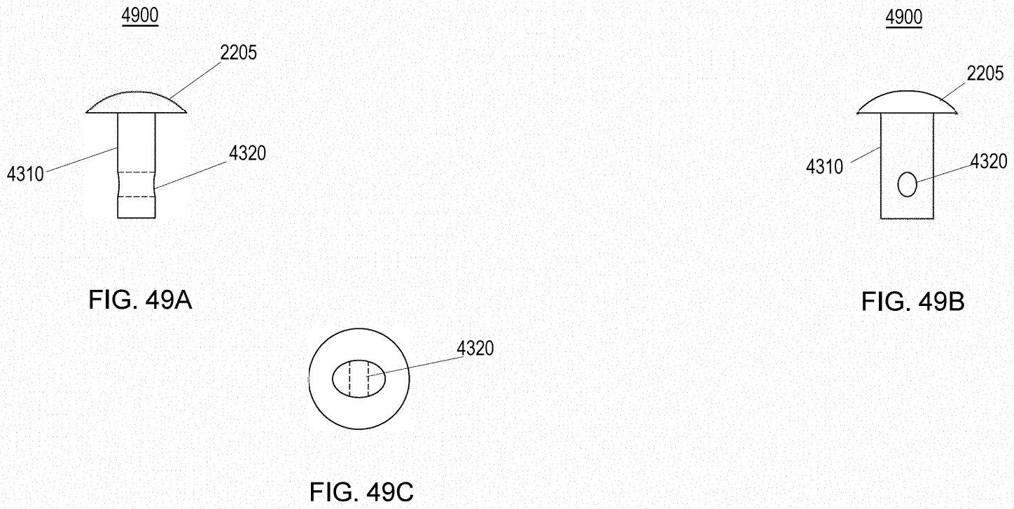

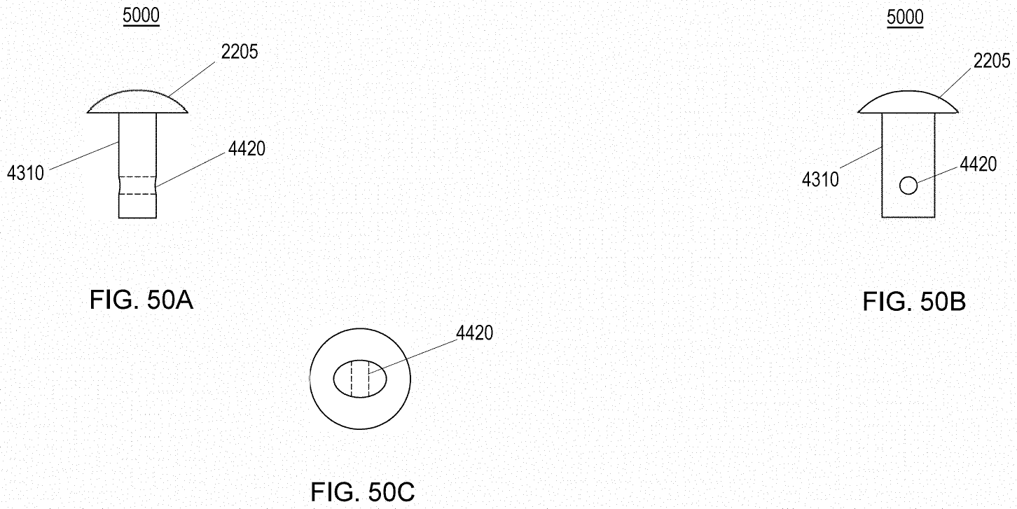

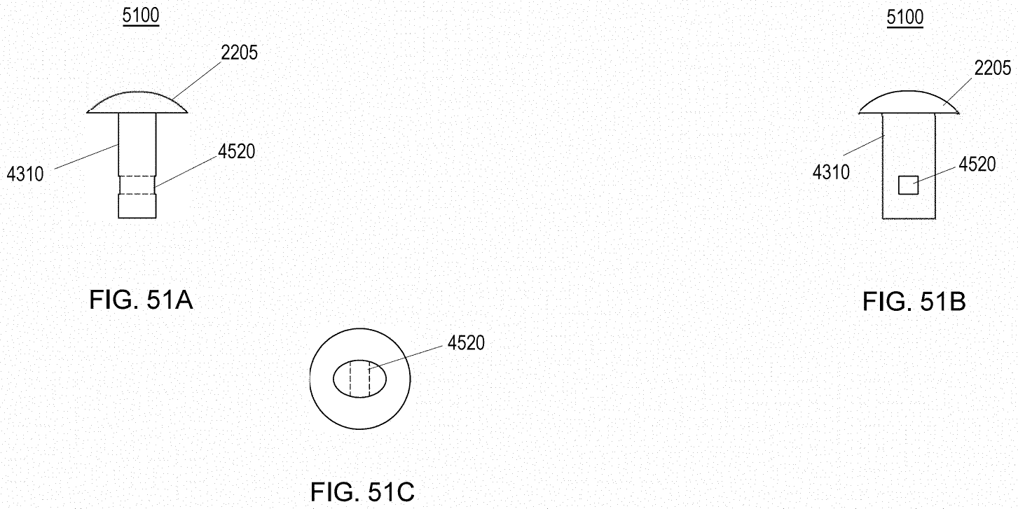

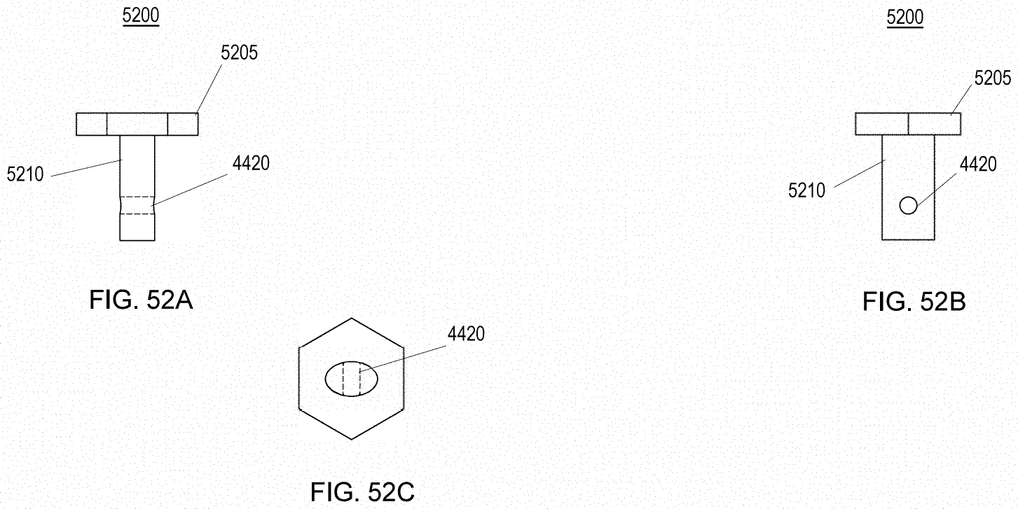

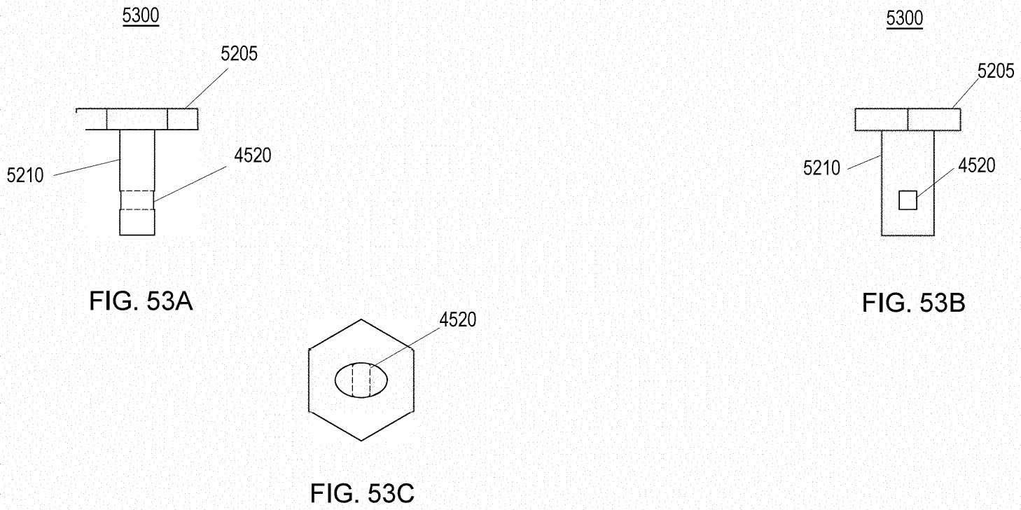

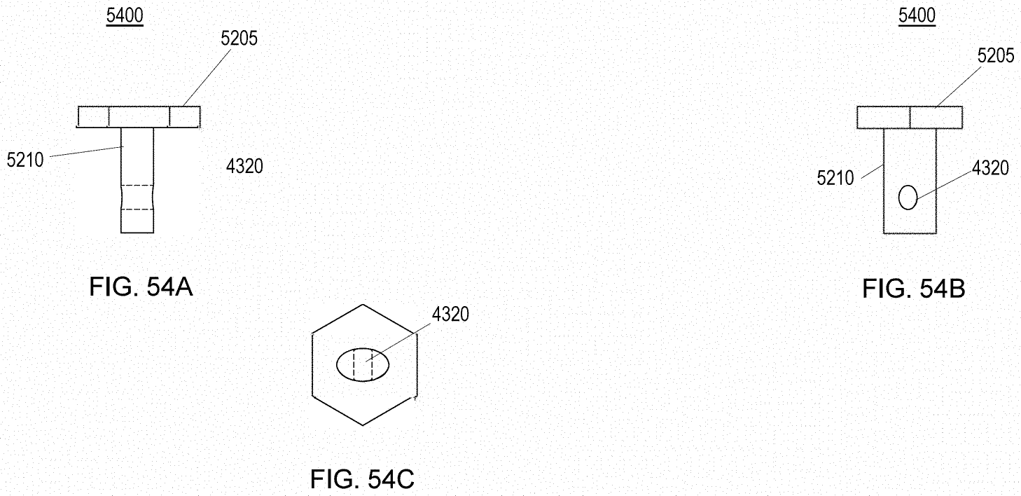

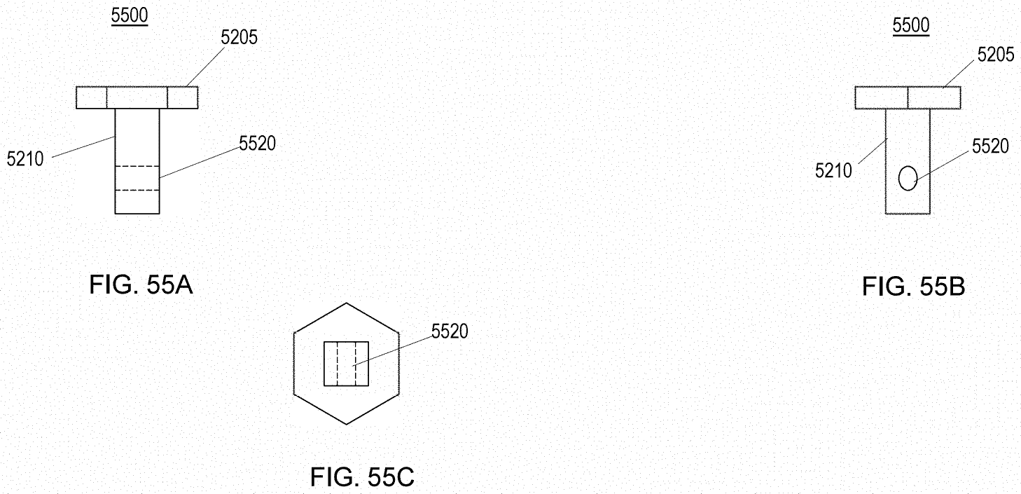

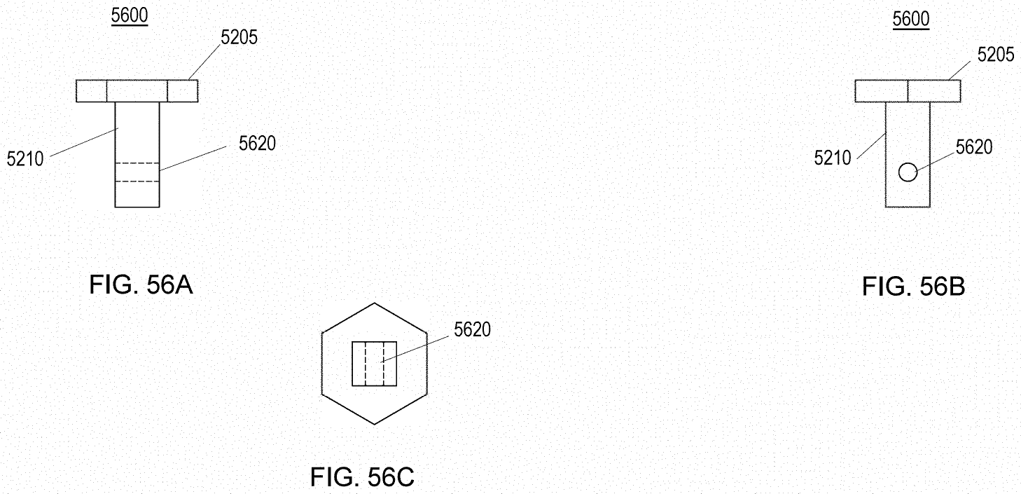

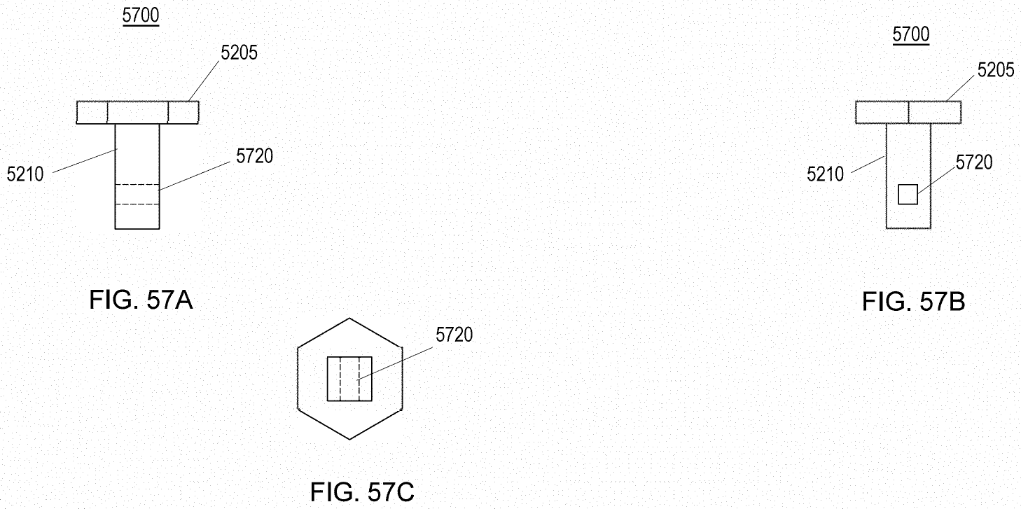

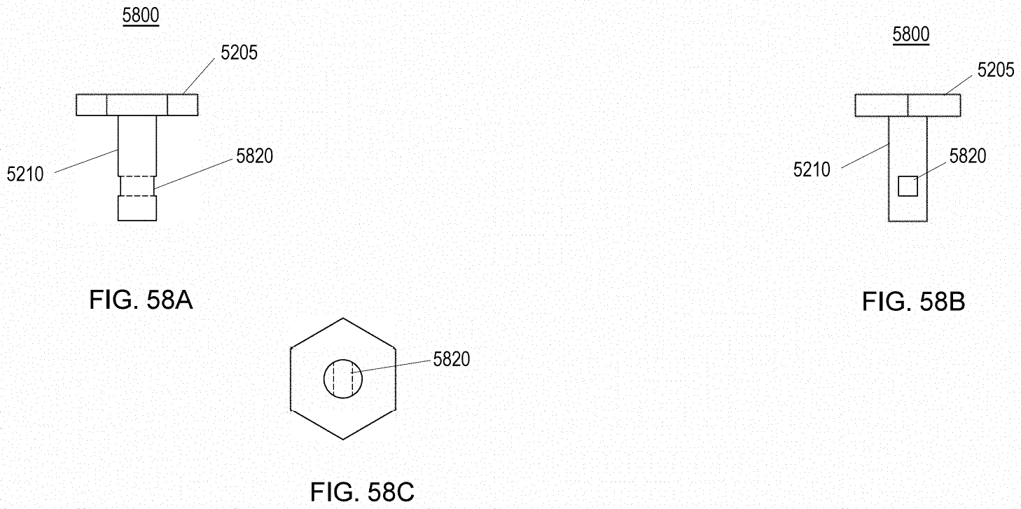

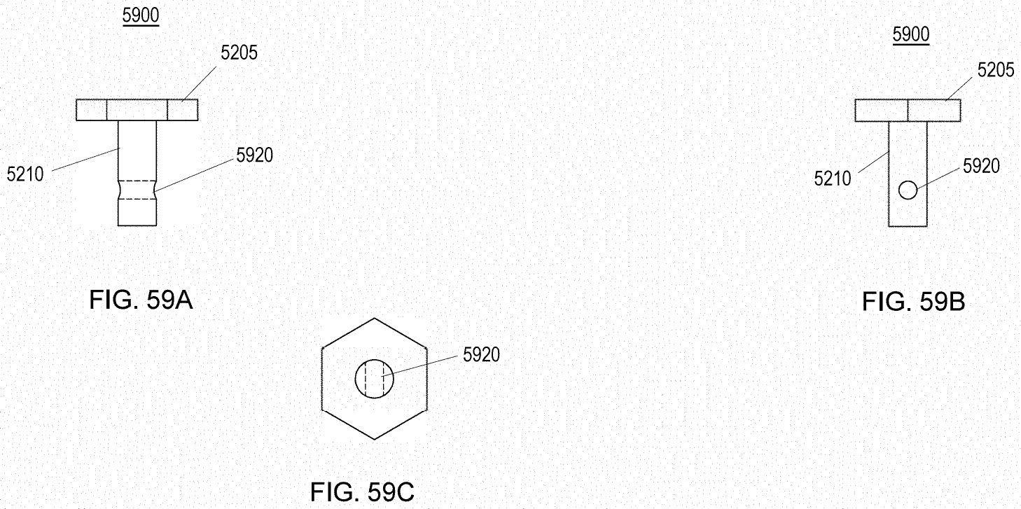

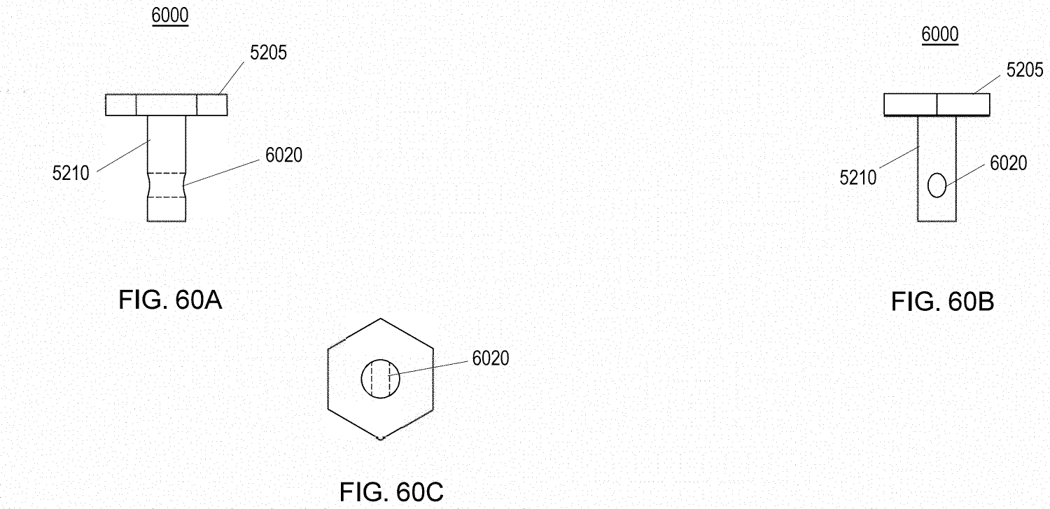

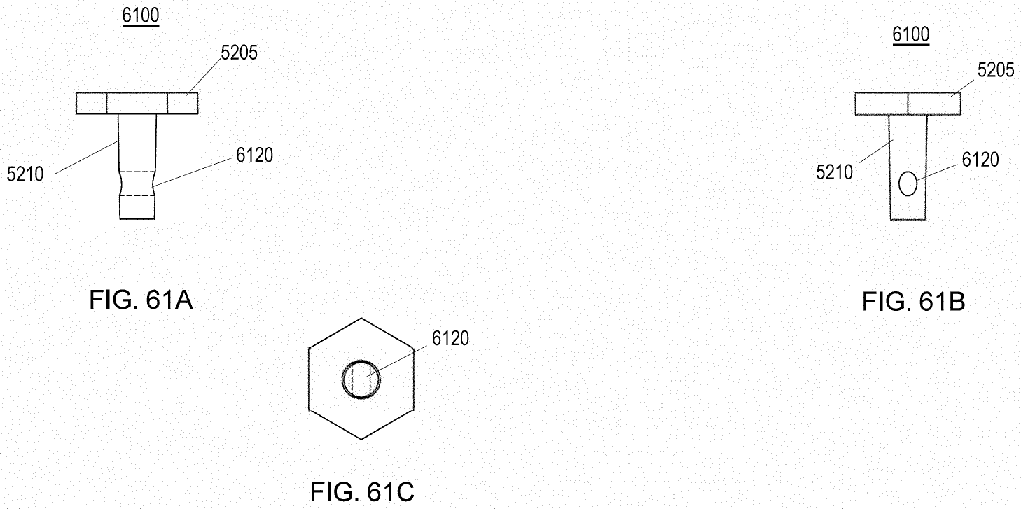

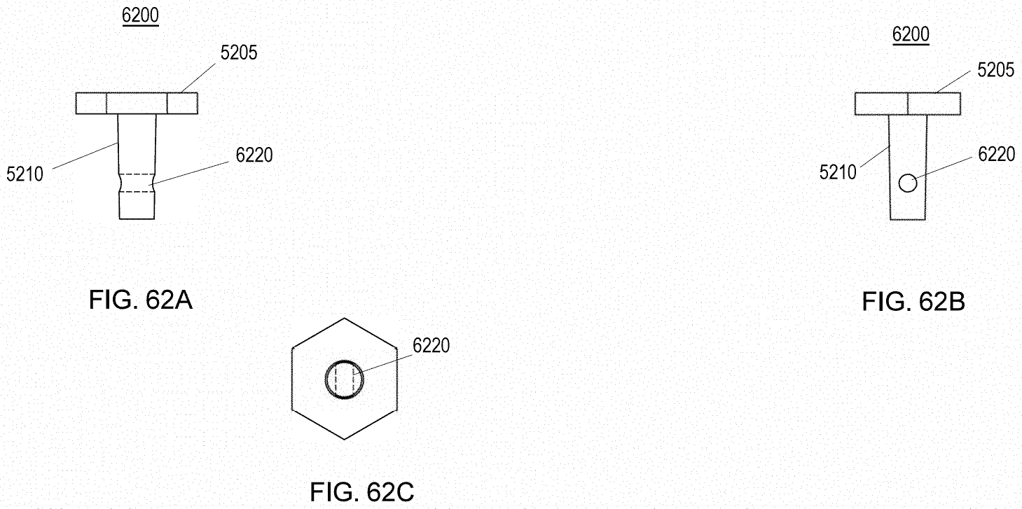

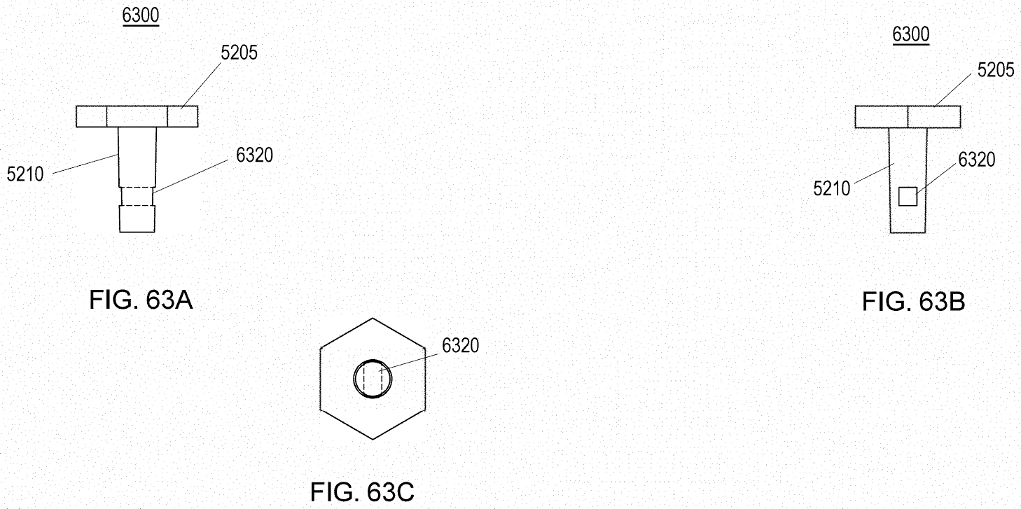

FIGS. 3A-63C show multiple different designs for drop-in anchors for (construction) beam catenary fall protection lines, according to some embodiments. In the plurality of embodiments, it can be seen that the top portion, body portion and anchor through-hole may have different sizes, shapes, facets, body tapers, top angles and tapers, etc. Some embodiments include the top portion having a round shape (see, e.g., top portions 305, FIG. 3A-C, FIGS. 43A-45C, drop-in anchor 300, FIG. 4, FIGS. 5A-9C, 3400, FIGS. 34A-36C, a polygonal shape anchor 1005, FIGS. 10A-15C; and FIGS. 52A-63C, a domed shape anchor 1605, FIGS. 16A-21C, 31A-33C, 46A-48C, a rounded top shape anchor 2205, FIGS. 22A-30C, 49A-51C, etc. In some embodiments, the dome, rounded, angled, polygonal, etc. shapes of the top portion assist a worker to slide over the drop-in anchor. This shape reduces or prevents a worker from tripping or losing balance when traversing a beam and crossing or moving over the drop-in anchor.

In some embodiments, the drop-in anchor through-hole (e.g., through-hole 220) may have a shape to accommodate a shackle or loop, such as a circular shape (e.g., through-hole 220, FIG. 2, 320, FIGS. 3A-C, 820, FIGS. 8A-C, 1120, FIGS. 11A-C, 1420, FIGS. 14A-C, 1720, FIGS. 17A-C, 2020, FIGS. 20A-C, 2320, FIGS. 23A-C, 2720, FIGS. 27A-C, 2820, FIGS. 28A-C, 3220, FIGS. 32A-C, 3520, FIGS. 35A-C, 3820, FIGS. 38A-C, 4120, FIGS. 41A-C, 4420, FIGS. 44A-C, FIGS. 47A-C, FIGS. 50A-C, FIGS. 52A-C, 5620, FIGS. 56A-C, 5920, FIGS. 59A-C, 6220, FIGS. 62A-C), a square shape (e.g., through-hole 520, FIGS. 5A-C, 920. FIGS. 9A-C, 1020, FIGS. 10A-C, 1520, FIGS. 15A-C, 1620, FIGS. 16A-C, 2120, FIGS. 21A-C, 2220, FIGS. 22A-C, 2620, FIGS. 26A-C, 2920, FIGS. 29A-C, 3320, FIGS. 33A-C, 3420, FIGS. 34A-C, 3920, FIGS. 39A-C, 4020, FIGS. 40A-C, 4520, FIGS. 45A-46C, FIGS. 51A-C, FIGS. 53A-C, 5720, FIGS. 57A-C, 5820, FIGS. 58A-C, 6320, FIGS. 63A-C), an oval shape (e.g., through-hole 620, FIGS. 6A-C, 720, FIGS. 7A-C, 1220, FIGS. 12A-C, 1320, FIGS. 13A-C, 1820, FIGS. 18A-C, 1920, FIGS. 19A-C, 2420, FIGS. 24A-C, 2520, FIGS. 25A-C, 3020, FIGS. 30A-C, 3120, FIGS. 31A-C, 3620, FIGS. 36A-C, 3720, FIGS. 37A-C, 4220, FIGS. 42A-C, 4320, FIGS. 43A-C, FIGS. 48A-49C, FIGS. 54A-C, 5520, FIGS. 55A-C, 6020, FIGS. 60A-C, 6120, FIGS. 61A-C), polygonal shape, multi-faceted shape, etc.

In some embodiments, as shown in FIGS. 3A-63C the top portion and the body portion (e.g., body portion 210, FIG. 2, 310, FIGS. 3A-B, FIGS. 5-28 A-B, 2810, FIGS. 28-39 A-B, 4010, FIGS. 41-42 A-B, 4310 FIGS. 43-51 A-B, 5210 FIGS. 52-63 A-B) of the drop-in anchor are integral and formed or molded as one piece, or may be welded together. In one or more embodiments, the upper portion (e.g., upper portion 306, FIGS. 3A-B, FIGS. 5-39 A-B) of the body portion may be shaped for a snug fit within an opening in the beam 10, may be a weld portion that may be machined or left unfinished, etc.

In some embodiments, all sharp edges are removed from the drop-in anchor. In some embodiments, in FIGS. 3A-63C, critical dimensions are denoted by a round outline, and weld symbols are shown in accordance with AWS (American Welding Society) standard a2.4-2012. In some embodiments, any screw threads are made in accordance with ASME (American Society of Mechanical Engineers) standard b1.1-2003.

In some embodiments, the drop-in anchor is made of forged ANSI (American National Standards Institute) alloy steel (e.g., 4130, 4140, etc.). In one or more embodiments, the surface finish may be ASTM International (formerly American Society for Testing and Materials) B633 (standard specification for electrodeposited coatings of Zinc on Iron and Steel) type III SC 3 (Fe/Zn 12) clear Zinc, etc.).

In some embodiments, the top portion of the drop-in anchor may be painted or plated with a non-slip material, have bumps or raised portions for grip, etc. In some embodiments, the top portion of the drop-in anchor may be painted or colored (e.g., covered with a wrap, adhered with a material, etc.) for indication and location determination in lower lighting (e.g., glow in dark, bright colors, reflective, etc.).

In one embodiment, the drop-in anchor may include a beacon or lighting for determining position and recognizing location of the drop-in anchor. In some embodiments, a BLUETOOTH® or other wireless receiver/transmitter device may be attached to the drop-in anchor for providing a signal (e.g., sound, vibration, haptic indication, etc.) to a worker having a BLUETOOTH® device (e.g., cell phone, smart device, receiver/transmitter, etc.) for signaling distance to the drop-in anchor.

In some embodiments, the beam 10 may include a portion above its through-hole that is cut out or depressed to fit the shape of the top portion of the drop-in anchor such that the top portion of the drop-in anchor is flush fitted with the top portion of the beam. These embodiments eliminate the protrusion above the beam 10 to eliminate the potential for a worker traversing the beam to trip or lose balance by coming in contact with one of the sides of the top portion pf the drop-in anchor.

In one or more embodiments, the anchor (or anchorage connector) may be implemented for use with steel beam 10 catenary lines. The drop-in anchorage connector body portion (or post) is placed through holes in an I-beam flange to connect via a shackle for a ⅜ inch diameter wire rope catenary line 20 (FIG. 1D) to create an anchor subsystem. In some embodiments, the drop-in anchorage connector post drops through precut holes in the I-beam 10 into I-beam flanges. Underneath the flange, a ⅜″ diameter wire rope preswaged catenary line 20 is attached to two anchor body portions (or posts (at each end of the beam 10 with shackles 21 or loops 22. In one or more embodiments, the anchor has a weight or force limit that is rated for 5,000 lb. In one embodiment, the entire anchor and catenary system is rated for 5,000 lb. One or more embodiments replace the conventional catenary beam line 100 system, which consists of looping the cable 20 through the holes in the I-beams 10 and then securing the loose ends of cable 20 on either end with multiple (e.g., three) cable clips or clamps.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should be emphasized that the above-described embodiments of the present invention, particularly, any “preferred” embodiments, are merely possible examples of implementations, merely set forth for a clear understanding of the principles of the invention.

Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A drop-in anchor for construction beam catenary lines, comprising:
a top portion having a first diameter; and
an elongated body portion having a second diameter and that is coupled to the top portion, the elongated body portion including a through-hole of a third diameter,
wherein the elongated body portion is configured to fit within a construction beam through-hole having a fourth diameter, the through-hole of the elongated body portion being configured for coupling with a catenary line connector, and the first diameter being larger than the fourth diameter.

2. The drop-in anchor of claim 1, wherein the second diameter being less than the fourth diameter.

3. The drop-in anchor of claim 2, wherein the top portion having a shape comprising one of:
round, oval, square, domed, polygonal or multi-faceted.

4. The drop-in anchor of claim 3, wherein the catenary line connector comprises a shackle or loop.

5. The drop-in anchor of claim 3, wherein the catenary line is a catenary fall protection line disposed underneath the construction beam.

6. The drop-in anchor of claim 3, wherein the through-hole of the elongated body portion is configured to be disposed below a bottom portion of the construction beam through-hole.

7. The drop-in anchor of claim 3, wherein the through-hole of the elongated body portion has a shape comprising one of: round, oval, square, polygonal or multi-faceted.

8. The drop-in anchor of claim 1, wherein the drop-in anchor has at least a 5,000 pound weight limit.

9. A drop-in anchor for construction beam catenary lines, comprising:
a top portion having a first diameter; and
an elongated body portion having a first end and a second end, the first end is coupled to the top portion, and the elongated body portion including a through-hole between the first end and the second end,
wherein the elongated body portion is configured to fit within a construction beam through-hole, the through-hole of the elongated body portion being configured for coupling with a catenary line connector.

10. The drop-in anchor of claim 9, wherein the elongated body portion has a second diameter, the through-hole of the elongated body portion has a third diameter, and the construction beam through-hole has a fourth diameter.

11. The drop-in anchor of claim 10, wherein the first diameter is larger than the fourth diameter, and the second diameter is less than the fourth diameter.

12. The drop-in anchor of claim 10, wherein the top portion has a shape comprising one of: round, oval, square, domed, polygonal or multi-faceted.

13. The drop-in anchor of claim 10, wherein the catenary line connector comprises a shackle or loop.

14. The drop-in anchor of claim 10, wherein the catenary line is fall protection cable disposed underneath the construction beam.

15. The drop-in anchor of claim 10, wherein the through-hole of the elongated body portion is configured to be disposed below a bottom portion of the construction beam through-hole.

16. The drop-in anchor of claim 10, wherein the through-hole of the elongated body portion has a shape comprising one of: round, oval, square, polygonal or multi-faceted.

17. The drop-in anchor of claim 8, wherein the drop-in anchor has at least a 5,000 pound weight limit.
